(19) United States
(12) Patent Application Publication
(10) Pub. No.: US 2026/0316841 A1
(43) Pub. Date: Oct. 15, 2026

(54) IMPACT ABSORBING MEMBER, MANUFACTURING METHOD OF IMPACT ABSORBING MEMBER FOR AUTOMOBILE, AND MANUFACTURING METHOD OF SIDE SILL

(71) Applicant: G-TEKT CORPORATION, Saitama (JP)

(72) Inventors: Hiroki ITO, Tokyo (JP); Kazuya MIYABORI, Tochigi (JP); Takashi KUBO, Tokyo (JP)

(21) Appl. No.: 19/113,765

(22) PCT Filed: Jul. 18, 2023
(86) PCT No.: PCT/JP2023/026249

§ 371 Date: Mar. 20, 2025

(30) Foreign Application Priority Data
Sep. 21, 2022 (JP) 2022-149908
Mar. 23, 2023 (JP) 2023-046232

(51) Int. Cl. B62D 25/02; B21C 3/02; B62D 21/15

(52) U.S. Cl. CPC B62D 25/025; B21C 3/02; B62D 21/157

(57) ABSTRACT

The method includes a member constituting a half of a closed cross-sectional profile forming step of forming a member constituting a half of a closed cross-sectional profile (17, 18) by press-forming a steel plate blank into a part having a hat-shaped cross-section including a hat portion (17a, 18a) and a pair of flange portions. The method further includes a structure configuring a closed cross-sectional profile forming step of forming a plurality of structures each configuring a closed cross-sectional profile coupled by connecting segments (15) in a longitudinal direction by combining at least two members each constituting a half of a closed cross-sectional profile. The hat portion includes at least a pair of corner ridges extending perpendicularly to the longitudinal direction. The structure configuring a closed cross-sectional profile includes a connecting segment (15) lined up with an upper or lower surface of the hollow body (14) and the connecting segment (15) is arranged along the longitudinal direction, with the connecting segment being offset in the up-down direction from a centroid of the hollow body. It is possible to produce inexpensive impact absorbing members made of steel plates with good productivity.

### TECHNICAL FIELD

The present invention relates to an impact absorbing member that absorbs impacts applied laterally to a vehicle body of an automobile, a manufacturing method of an impact absorbing member for an automobile, and a manufacturing method for a side sill.

### BACKGROUND ART

Conventionally, a reinforcing member for reinforcing a side portion of an automobile body is disclosed, for example, in Patent Document 1. The reinforcing member disclosed in this publication is provided inside a side sill of a vehicle body, and has a plurality of hollow portions that have a shape of a closed cross-sectional profile when viewed from the vehicle front-rear direction. The plurality of hollow portions are formed by extrusion molding using an aluminum alloy as the material, and extend in the vehicle front-rear direction while being lined up in the vehicle width direction. The reinforcing member absorbs an impact applied to the side of the vehicle body toward the inside of the vehicle body by making the hollow portions crush.

### CITATION LIST

Patent Document 1: JP 2018-090021 A

### SUMMARY OF THE INVENTION

The reinforcing member described in Patent Document 1 has a problem in that the manufacturing cost is high because the aluminum alloy is more expensive than a steel plate and the cost of equipment for extrusion molding is high.

The present invention aims to produce inexpensive impact absorbing members made of steel plates with good productivity.

In order to achieve the objective, a method for manufacturing an impact absorbing member according to an aspect of the present invention includes the steps of:
a member constituting a half of a closed cross-sectional profile forming step of forming a member constituting a half of a closed cross-sectional profile by press-forming a steel plate blank into a part having a hat-shaped cross-section including a hat portion and a pair of flange portions; and
a structure configuring a closed cross-sectional profile forming step of forming a plurality of structures each configuring a closed cross-sectional profile coupled by connecting segments in only a longitudinal direction by combining at least two members each constituting a half of a closed cross-sectional profile in such a manner that there are members each constituting a half of a closed cross-sectional profile having convex directions of the hat portions opposite to each other, overlapping and joining a top portion of the hat portion of one member constituting a half of a closed cross-sectional profile with the flange portion of another member constituting a half of a closed cross-sectional profile, wherein
the hat portion includes at least a pair of corner ridges extending perpendicularly to the longitudinal direction,
the structure configuring a closed cross-sectional profile includes a connecting segment lined up with an upper or lower surface of a hollow body, and
the connecting segment is arranged in the front-rear direction with the connecting segment being offset from a centroid of the hollow body in an up-down direction.

A method for manufacturing a side sill according to an aspect of the present invention includes the steps of:
a step of joining an impact absorbing member formed by the impact absorbing member manufacturing method according to any one of claims 1-13 to an outer side sill; and
a step of joining the outer side sill, to which the impact absorbing member is joined, and an inner side sill.

An impact absorbing member according to an aspect of the present invention includes
a plurality of structures each configuring a closed cross-sectional profile formed by combining at least two members each constituting a half of a closed cross-sectional profile each having a hat portion and a pair of flange portions and formed to have a hat-shaped cross-section, with the members each constituting a half of a closed cross-sectional profile being in a posture in which convex directions of the hat portions are opposite to each other, wherein
a top portion of the hat portion of one member constituting a half of a closed cross-sectional profile is joined to the flange portion of another member constituting a half of a closed cross-sectional profile in an overlapping state, and
the structure configuring a closed cross-sectional profile includes a plurality of hollow bodies and a connecting segment that connects the hollow bodies only in a longitudinal direction of the structure configuring a closed cross-sectional profile,
the hat portion includes at least a pair of corner ridges extending perpendicularly to the longitudinal direction, and
the connecting segment is lined up with an upper or lower surface of the hollow body and is arranged along the longitudinal direction, with the connecting segment being offset in an up-down direction from a centroid of the hollow body.

According to the present invention, at least two sets of steel plates are made in which a half (hat portion) of the hollow body and the connecting segment (flange portion) are formed by bending press processing, and the steel plates are combined to form an impact absorbing member.

Therefore, an impact absorbing member can be manufactured by subjecting a steel plate, which is inexpensive than an aluminum alloy, to simple bending press processing and welding (or rivets or other coupling means). Thus, it is possible to provide an inexpensive impact absorbing member made of steel plate.

In particular, if there is one mold for press-forming a hat portion and flange portions, an impact absorbing member of any length can be obtained inexpensively by connecting multiple hat portions in the longitudinal direction via the flange portions in a stepping-stone fashion. By simply adding recesses to the flange portions, the number of corner ridges of the hollow structure can be increased, thereby increasing the absorption amount of impact energy. This is because when a load is applied to the hollow structure from the side, the corner ridges buckle successively from a leading end to a base end, thereby absorbing the impact energy.

Moreover, in accordance with the present invention, the impact absorbing member can be attached to the outer side sill using a fixing member, and the outer side sill can be attached to the inner side sill with the outer side sill and the impact absorbing member being in an integrated form, thereby enabling automobile side sills to be manufactured productively using an impact absorbing member formed by steel plate.

### BRIEF DESCRIPTION OF THE DRAWINGS

FIG. 1 shows a perspective view of a portion of an automobile body frame, illustrating an exploded side sill.

FIG. 2 shows a cross-sectional view of a side sill.

FIG. 3A shows a perspective view of an impact absorbing member.

FIG. 3B shows a front view of the impact absorbing member.

FIG. 4A shows a perspective view of a member constituting a half of a closed cross-sectional profile.

FIG. 4B shows a perspective view of the member constituting a half of a closed cross-sectional profile.

FIG. 4C shows a perspective view of a structure configuring a closed cross-sectional profile.

FIG. 5A shows a perspective view of a member constituting a half of a closed cross-sectional profile having an outer sill fixing member.

FIG. 5B shows a perspective view of a member constituting a half of a closed cross-sectional profile having an outer sill fixing member.

FIG. 6A shows a front view of a portion of the impact absorbing member, illustrating an example of formation of the outer sill fixing member.

FIG. 6B shows a front view of a portion of the impact absorbing member, illustrating an example of formation of the outer sill fixing member.

FIG. 7 shows a flow chart for explaining an example of a method for manufacturing the impact absorbing member.

FIG. 8A shows a front view for explaining an example of a manufacturing method of the impact absorbing member.

FIG. 8B shows a front view for explaining an example of a manufacturing method of the impact absorbing member.

FIG. 8C shows a front view for explaining an example of a manufacturing method of the impact absorbing member.

FIG. 8D shows a front view for explaining an example of a manufacturing method of the impact absorbing member.

FIG. 9 shows a flow chart for explaining an example of a method for manufacturing the impact absorbing member.

FIG. 10 shows a perspective view for explaining an example of a manufacturing method of the impact absorbing member.

FIG. 11 shows a flow chart for explaining an example of a method for manufacturing the impact absorbing member.

FIG. 12 shows a perspective view for explaining an example of a manufacturing method of the impact absorbing member.

FIG. 13 shows a flow chart for explaining an example of a method for manufacturing the impact absorbing member.

FIG. 14 shows a front view for explaining an example of a manufacturing method of the impact absorbing member.

FIG. 15 shows a flowchart illustrating an example of a manufacturing method of the side sill.

FIG. 16A shows a cross-sectional view for explaining an example of a manufacturing method of the side sill.

FIG. 16B shows a cross-sectional view for explaining an example of a manufacturing method of the side sill.

FIG. 16C shows a cross-sectional view for explaining an example of a manufacturing method of the side sill.

FIG. 17 shows a flowchart for explaining a modification example of a manufacturing method of the side sill.

FIG. 18 shows a schematic view for explaining a configuration of the impact absorbing member.

FIG. 19 shows a schematic view for explaining a configuration of the side sill.

FIG. 20 shows a cross-sectional view for explaining an impact absorbing principle of the impact absorbing member.

FIG. 21A shows a cross-sectional view for explaining an impact absorbing principle of the impact absorbing member.

FIG. 21B shows a cross-sectional view for explaining an impact absorbing principle of the impact absorbing member.

FIG. 22A shows a perspective view illustrating another embodiment of the member constituting a half of a closed cross-sectional profile.

FIG. 22B shows a perspective view illustrating another embodiment of the member constituting a half of a closed cross-sectional profile.

FIG. 22B shows a perspective view illustrating another embodiment of the impact absorbing member.

FIG. 23B shows a perspective view illustrating another embodiment of the impact absorbing member.

FIG. 24A shows a cross-sectional view illustrating a modification example of a closed cross-sectional profile having a corner.

FIG. 24B shows a cross-sectional view illustrating a modification example of a closed cross-sectional profile having a corner.

FIG. 24C shows a cross-sectional view illustrating a modification example of a closed cross-sectional profile having a corner.

FIG. 24D shows a cross-sectional view illustrating a modification example of a closed cross-sectional profile having a corner.

FIG. 24E shows a cross-sectional view illustrating a modification example of a closed cross-sectional profile having a corner.

FIG. 25A shows a perspective view illustrating a modified example of a pressed steel plate constituting the impact absorbing member.

FIG. 25B shows a perspective view illustrating a modification example of the impact absorbing member.

FIG. 26A shows a perspective view of an impact absorbing member having a connecting segment of outer connecting type.

FIG. 26B shows a cross-sectional view of a portion of an impact absorbing member.

FIG. 26C shows a cross-sectional view of a portion of an impact absorbing member.

FIG. 27A shows a schematic view for explaining the mechanism by which axial collapse occurs.

FIG. 27B shows a schematic view for explaining the mechanism by which axial collapse occurs.

FIG. 28A shows a schematic view for explaining the mechanism by which axial collapse occurs.

FIG. 28B shows a schematic view for explaining the mechanism by which axial collapse occurs.

FIG. 29 shows a graph showing changes in impact absorption energy.

FIG. 30 shows a perspective view illustrating a modification example of the impact absorbing member.

FIG. 31 shows an exploded perspective view of a structure configuring a closed cross-sectional profile showing a modification example of flange portions.

FIG. 32 shows a perspective view of a structure configuring a closed cross-sectional profile showing a modification example of flange portions.

### DETAILED DESCRIPTION OF THE INVENTION

### First Embodiment

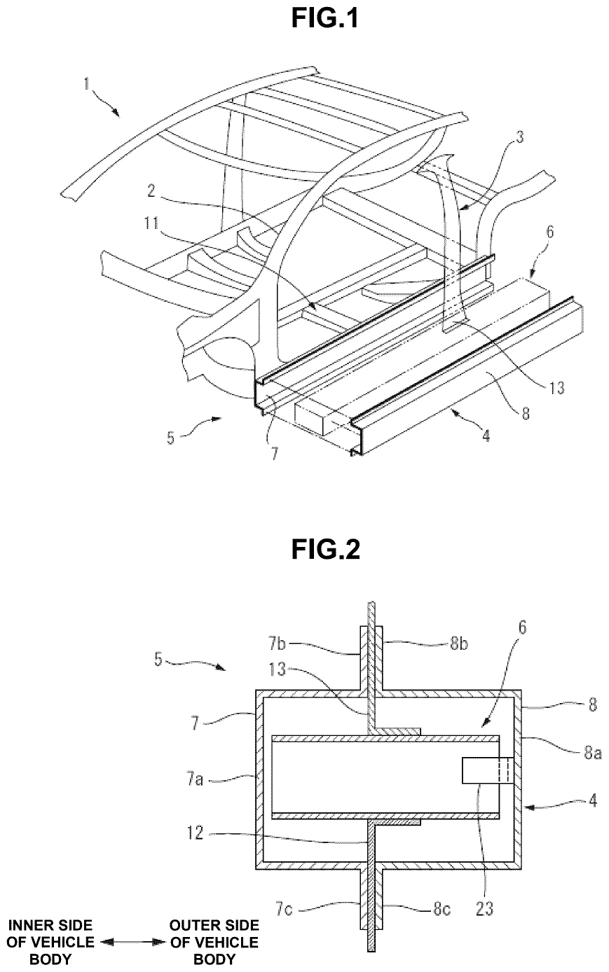

Hereinafter, embodiments of the impact absorbing member, the manufacturing method of an impact absorbing member, and the manufacturing method of a side sill according to the present invention will be described in detail with reference to FIGS. 1-21B.

An automobile body frame 1 shown in FIG. 1 can be used for an electrically-driven automobile (not illustrated), and includes an inner front pillar 2, an inner center pillar 3, and a side sill 4 at respective ends in the vehicle width direction. It should be noted that an outer front pillar and an outer center pillar are not shown in the drawings. FIG. 1 shows the side sill 4 in an exploded form.

### Side Sill

The side sill 4 according to this embodiment is formed by combining two components into a cylindrical shape extending in the vehicle front-rear direction. An impact absorbing member 6 that cooperates with the side sill 4 to form a side sill structure 5 is housed inside the side sill 4. The impact absorbing member 6 will be described in detail later.

The two components that constitute the side sill 4 are an inner side sill 7 that extends in the vehicle front-rear direction on the vehicle inner side, and an outer side sill 8 that extends in the vehicle front-rear direction on the vehicle outer side. As shown in FIG. 2, the inner side sill 7 and the outer side sill 8 each have a main body 7a, 8a, the cross-section whereof having a shape of a recess, and an upper flange 7b, 8b and a lower flange 7c, 8c for welding that are integrally formed on ends of the main body 7a, 8a.

The inner side sill 7 is welded to a floor panel (not illustrated) and a cross member 11 of the vehicle body frame 1 in a posture in which the opened part of the main body 7a, the cross-section whereof having a shape of a recess, orients the vehicle outer side.

The outer side sill 8 is welded to the inner side sill 7 in a state in which the opened part of the main body 8a, the cross-section whereof having a shape of a recess, orients the vehicle inner side. The upper flanges 7b, 8b of the inner side sill 7 and the outer side sill 8 protrude upward from upper ends of the main bodies 7a, 8a mounted on the vehicle. The lower flanges 7c, 8c protrude downward from lower ends of the main bodies 7a, 8a mounted on the vehicle. The upper flanges 7b, 8b and the lower flanges 7c, 8c extend from the front end to the rear end of the inner side sill 7 and the outer side sill 8. The welding of the inner side sill 7 and the outer side sill 8 is carried out by overlapping the upper flanges 7b, 8b of the inner side sill 7 and the outer side sill 8 with each other and spot welding them and by overlapping the lower flanges 7c, 8c with each other and spot welding them.

The impact absorbing member 6 is for absorbing a shock applied to the side sill 4 from the side of the vehicle body, and in this embodiment, extends from the front end to the rear end of the side sill 4 in the side sill 4. The impact absorbing member 6 can be set at a location and to a length in accordance with side impact test results, thereby enabling cost reduction. The longitudinal direction of the impact absorbing member 6 is the vehicle front-rear direction.

A holding member 12 for supporting the impact absorbing member 6 in the side sill 4 is welded to a lower end of the impact absorbing member 6. An inner center pillar coupling segment 13 that couples with the lower end of the inner center pillar 3 is welded to an upper end of the impact absorbing member 6. Although not illustrated, the inner center pillar 3 is provided with an outer center pillar and forms a closed cross-sectional profile that extends in the up-down direction.

A holding member 12 extending downward from the impact absorbing member 6 is fixed to the lower flanges 7c, 8c of the lower flanges 7c, 8c by spot welding while being sandwiched between the lower flanges 7c, 8c. Moreover, the inner center pillar coupling segment 13 extending upward from the impact absorbing member 6 is fixed to the upper flanges 7b, 8b of the upper flanges 7b, 8b by spot welding while being sandwiched between the upper flanges 7b, 8b. Furthermore, the inner center pillar coupling segment 13 securely fixes the lower part of the inner center pillar 3 via the impact absorbing member 6.

### Impact Absorbing Member

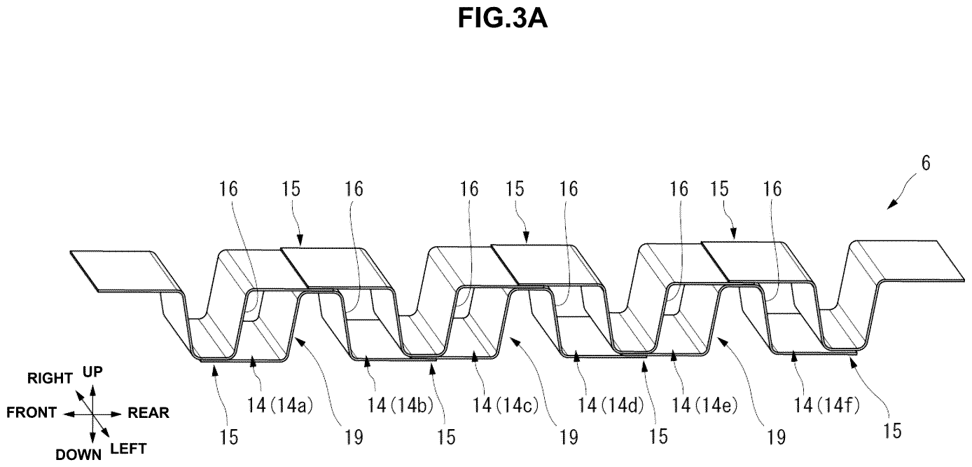

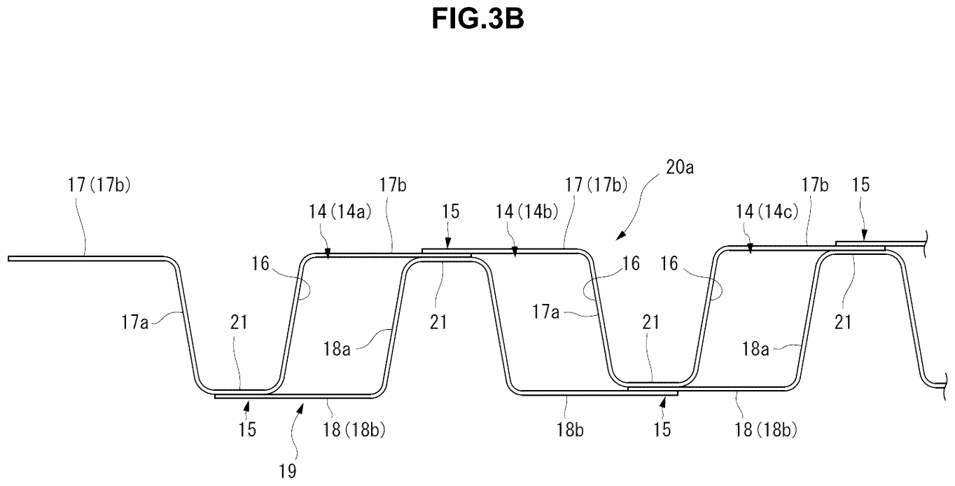

As shown in FIGS. 3A and 3B, the impact absorbing member 6 includes: a plurality of hollow bodies 14 arranged at predetermined intervals in the vehicle front-rear direction (from left to right in FIGS. 3A and 3B); and a plurality of connecting segments 15 that connect the hollow bodies 14 to each other. FIG. 3A shows a perspective view of the impact absorbing member 6, and FIG. 3B shows a front view of a part of the impact absorbing member 6 as viewed from the side of the vehicle body.

The hollow body 14 has a shape that forms a closed cross-sectional profile 16 when viewed from the side of the vehicle body of the automobile, and is formed in a cylindrical shape that extends in the vehicle width direction. The hollow body 14 according to this embodiment is formed in a prismatic hollow shape with the shape of the closed cross-sectional profile 16 being a parallelogram. Here, for convenience in identifying the multiple hollow bodies 14, the hollow bodies 14 are referred to as a first hollow body 14a, a second hollow body 14b, a third hollow body 14c, a fourth hollow body 14d, a fifth hollow body 14e, and a sixth hollow body 14f, in an order from the front to the rear of the vehicle body in FIG. 3A.

The connecting segment 15 is formed in a plate shape extending in the front-rear direction and the width direction of the vehicle body, and connects two adjacent hollow bodies 14 to each other at positions where there is an offset between the two adjacent hollow bodies 14 in the up-down direction, i.e., at positions where there is a difference between the two adjacent hollow bodies 14 in the up-down direction. When three or more hollow bodies 14 are provided and a plurality of connecting segments 15 are provided in the vehicle front-rear direction as shown in FIGS. 3A and 3B, the positions of the connecting segments 15 in the up-down direction are alternately distributed along the vehicle front-rear direction. That is, the connecting segment 15 connecting the first hollow body 14a and the second hollow body 14b together connects the upper ends of the first and second hollow bodies 14a, 14b with each other, whereas the connecting segment 15 connecting the second hollow body 14b and the third hollow body 14c together connects the lower ends of the second and third hollow bodies 14b, 14c with each other.

The impact absorbing member 6 shown in FIGS. 3A and 3B includes hollow structures 19 each having two closed cross-sectional profiles 16. The hollow structure 19 is formed so as to have a pair of parallelograms arranged to have a widening shape, with the distance between the parallelograms gradually increasing from top to bottom when viewed in the cross-sectional direction (vehicle width direction) of the closed cross-sectional profile 16. In the following, such a shape in which a pair of parallelograms or shapes similar to parallelograms are arranged to have a widening shape will be simply referred to as a “widening shape.”

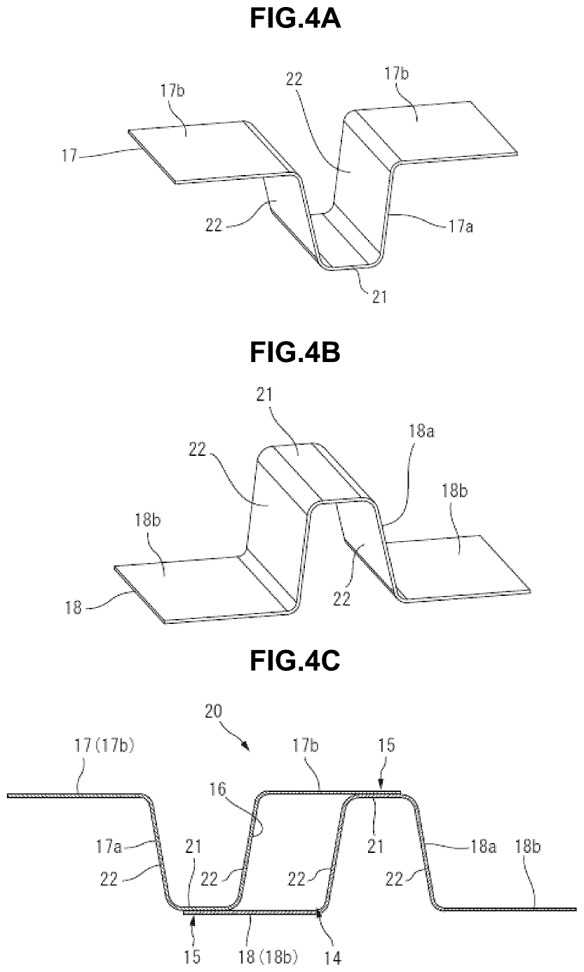

The hollow body 14 and the connecting segment 15 described above are formed by combining first and second members each constituting a half of a closed cross-sectional profile 17, 18 shown in FIGS. 4A and 4B with each other as shown in FIG. 4C to form a structure configuring a closed cross-sectional profile 20. FIG. 4A shows a perspective view illustrating the first member constituting a half of a closed cross-sectional profile 17. FIG. 4B shows a perspective view showing the second member constituting a half of a closed cross-sectional profile 18. FIG. 4C shows a cross-sectional view of the structure configuring a closed cross-sectional profile 20.

The first member constituting a half of a closed cross-sectional profile 17 and the second member constituting a half of a closed cross-sectional profile 18 are each formed to have a hat-shaped cross-section by pressing a steel plate, and each has two functional parts.

The first functional part is a hat portion 17a, 18a located in the central portion of the vehicle body in the front-rear direction (left-right direction in FIGS. 4A and 4B) and formed to have a cross-section having a shape of a recess. The hat portions 17a, 18a each have a flat top portion 21 and a pair of inclined walls 22 connected to the front and rear ends of the top portion and extending in the up-down direction. The top portion 21 is formed flat so as to extend in the horizontal direction. The pair of inclined walls 22 constitute the sides of the hat portions 17a, 18a, and are inclined in such a direction that the distance between the inclined walls 22 gradually increases with increasing distance from the top portion 21, facilitating press-forming. An end of the inclined wall 22 constitutes a flange portion that is bent to be parallel to the top portion 21 so as to be connected to a second functional part described later. The inclined wall 22 of the first member constituting a half of a closed cross-sectional profile 17 shown in FIG. 4A extends upwardly from the top portion 21. The inclined wall 22 of the second member constituting a half of a closed cross-sectional profile 18 shown in FIG. 4B extends downwardly from the top portion 21.

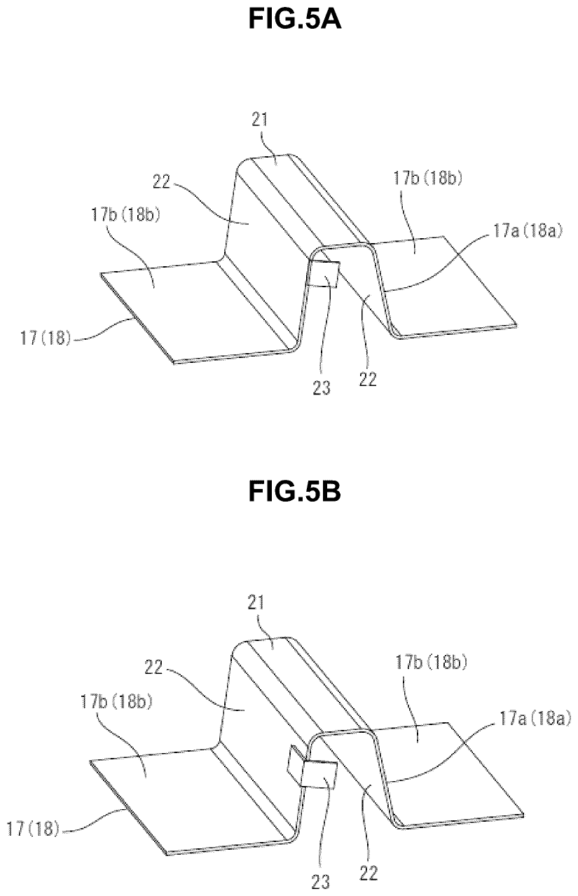

The inclined wall 22 may be provided with an (outer sill) fixing member 23 as shown in FIGS. 5A and 5B. The (outer sill) fixing member 23 is for connecting the impact absorbing member 6 to the outer side sill 8 or the inner side sill, and is formed in a plate shape extending from one inclined wall 22 toward the other inclined wall 22 (towards the outer side of the closed cross-sectional profile 16).

There are two methods for installing the (outer sill) fixing member 23 on the inclined wall 22. The first method is to form it integrally with the inclined wall 22 as shown in FIG. 5A. The second method is to form it separately from the inclined wall 22 and weld it to the inclined wall 22 as shown in FIG. 5B.

The second functional part is constituted by a pair of flange portions 17b, 18b (see FIGS. 4A and 4B) protruding from both ends of the hat portion 17a, 18a in the longitudinal direction of the impact absorbing member 6. The flange portions 17b, 18b constitute the upper and lower ends of the hollow body 14 and the connecting segment 15, and are formed in the shape of a flat plate extending in the horizontal direction, protruding from the tip (lower end or upper end) of the inclined wall 22 in the vehicle front-rear direction.

The first member constituting a half of a closed cross-sectional profile 17 and the second member constituting a half of a closed cross-sectional profile 18 may have the same shape or different shapes. For example, depending on the required impact absorbing mode, the number of hat portions on one side can be greater than the other, and the length/thickness/strength of the top portion 21/inclined wall 22 can be increased or decreased, or the shape thereof can be changed. Of course, if the first member constituting a half of a closed cross-sectional profile 17 and the second member constituting a half of a closed cross-sectional profile 18 have the same shape, only one press-forming die is required, which reduces equipment costs.

As shown in FIG. 4C, the first member constituting a half of a closed cross-sectional profile 17 and the second member constituting a half of a closed cross-sectional profile 18 are joined to each other in a state in which the convex directions of the first member constituting a half of a closed cross-sectional profile 17 and the second member constituting a half of a closed cross-sectional profile 18 are opposite in the up-down direction, and the top portion 21 of the first member constituting a half of a closed cross-sectional profile 17 and the second member constituting a half of a closed cross-sectional profile 18 overlap with ends of the flange portions 17b, 18b on one sides. FIG. 4C shows a state in which the top portion 21 of the first member constituting a half of a closed cross-sectional profile 17 overlaps with the end of the flange 18b of the second member constituting a half of a closed cross-sectional profile 18 on the front side of the vehicle body, and the end of the flange 17b of the first member constituting a half of a closed cross-sectional profile 17 on the rear side of the vehicle body overlaps with the top portion 21 of the second member constituting a half of a closed cross-sectional profile 18.

The first member constituting a half of a closed cross-sectional profile 17 and the second member constituting a half of a closed cross-sectional profile 18 are joined together by spot welding at the two overlapping portions mentioned above. By joining the first member constituting a half of a closed cross-sectional profile 17 and the second member constituting a half of a closed cross-sectional profile 18 in this manner, a structure configuring a closed cross-sectional profile 20 is formed such that a closed cross-sectional profile 16 (hollow body 14) is formed constituted by the inclined walls 22, 22 of the opposing hat portions 17a, 18a of the first and second member constituting a half of a closed cross-sectional profile portions 17, 18, and the opposing flange portions 17b, 18b.

A first member constituting a half of a closed cross-sectional profile 17 is added to the rear portion (the right end in FIG. 4C) of the structure configuring a closed cross-sectional profile 20 shown in FIG. 4C, and adjacent hat portions 17a, 18b are combined in such a manner that their convex directions are opposite to each other, thereby forming a hollow structure 19 as shown in FIG. 3B. In this case, the top portion 21 of the hat portion 17a (18a) of one member constituting a half of a closed cross-sectional profile 17 (18) are overlapped and joined to the flange portion 18a (18b) of the other member constituting a half of a closed cross-sectional profile 18 (17). By combining one member constituting a half of a closed cross-sectional profile with the structure configuring a closed cross-sectional profile 20 in this manner, a second structure configuring a closed cross-sectional profile 20a (see FIG. 3B) is formed. The second structure configuring a closed cross-sectional profile 20a has a hollow structure 19 that has a widening shape as described above.

### Manufacturing Method of Impact Absorbing Member

There are four methods for manufacturing the impact absorbing member 6 extending in the vehicle front-rear direction using the first member constituting a half of a closed cross-sectional profile 17 and the second member constituting a half of a closed cross-sectional profile 18, as described below.

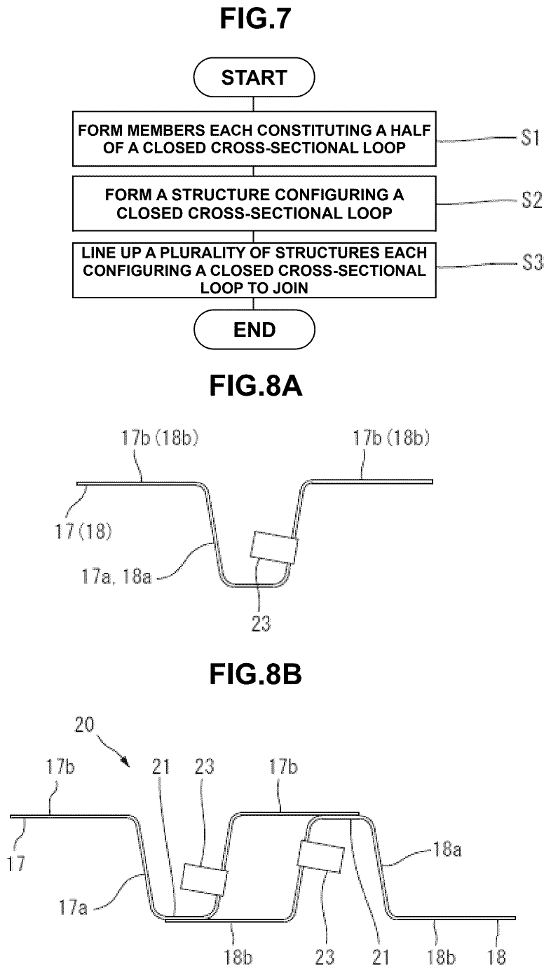

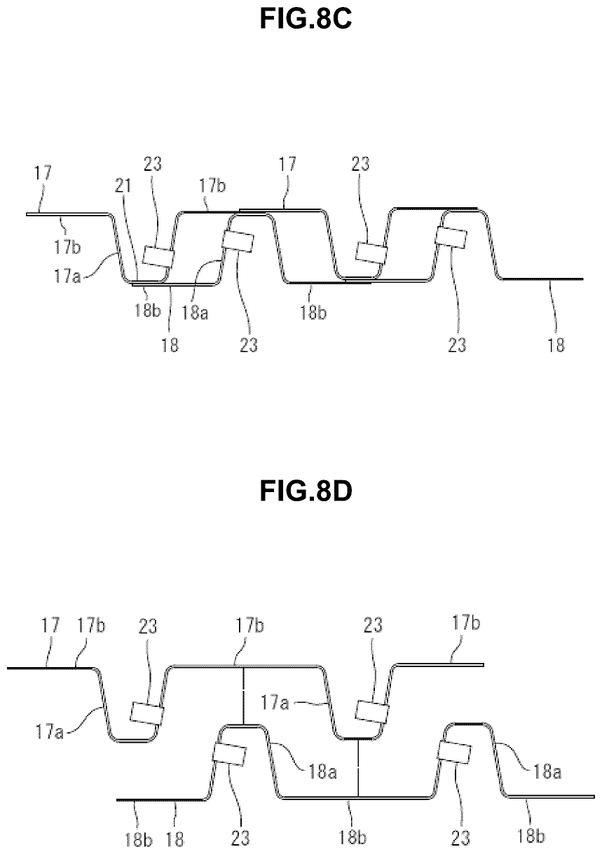

The first manufacturing method is carried out as shown in the flow chart of FIG. 7. First, as shown in step S1 of the flow chart of FIG. 7, the first member constituting a half of a closed cross-sectional profile 17 and the second member constituting a half of a closed cross-sectional profile 18 are each press-formed (see FIG. 8A). In the case where the outer sill fixing member 23 is formed integrally with the first and second members each constituting a half of a closed cross-sectional profile 17, 18, the outer sill fixing member 23 is bent in the longitudinal direction of the impact absorbing member 6 in this process.

When welding the outer sill fixing member 23 to the first member constituting a half of a closed cross-sectional profile 17 and the second member constituting a half of a closed cross-sectional profile 18, such welding is carried out in this step.

Next, as shown in FIG. 8B, the first member constituting a half of a closed cross-sectional profile 17 and the second member constituting a half of a closed cross-sectional profile 18 are combined and welded to form a structure configuring a closed cross-sectional profile 20 (step S2). The structure configuring a closed cross-sectional profile (hollow body) 20 is formed in a number corresponding to the length of the impact absorbing member 6. For example, as shown in FIG. 8D, a blank may be press-formed to form a first member constituting a half of a closed cross-sectional profile 17 and a second member constituting a half of a closed cross-sectional profile 18 such that the two hat portions 17a, 18a are lined up consecutively, with one of the pair of flange portions 17b, 18b located on both sides of the hat portions 17a, 18a being common. Then, as shown in FIG. 8C, a plurality of structures each configuring a closed cross-sectional profile 20 are lined up in the vehicle front-rear direction, and adjacent structures each configuring a closed cross-sectional profile 20 are welded to each other. At this time, the top portions 21 of the hat portions 17a, 18a and the flange portions 17b, 18b are overlapped, and the overlapped portions are welded by spot welding (step S3). By joining the plurality of structures each configuring a closed cross-sectional profile 20 in this manner, an impact absorbing member 6 having an elongated shape is completed.

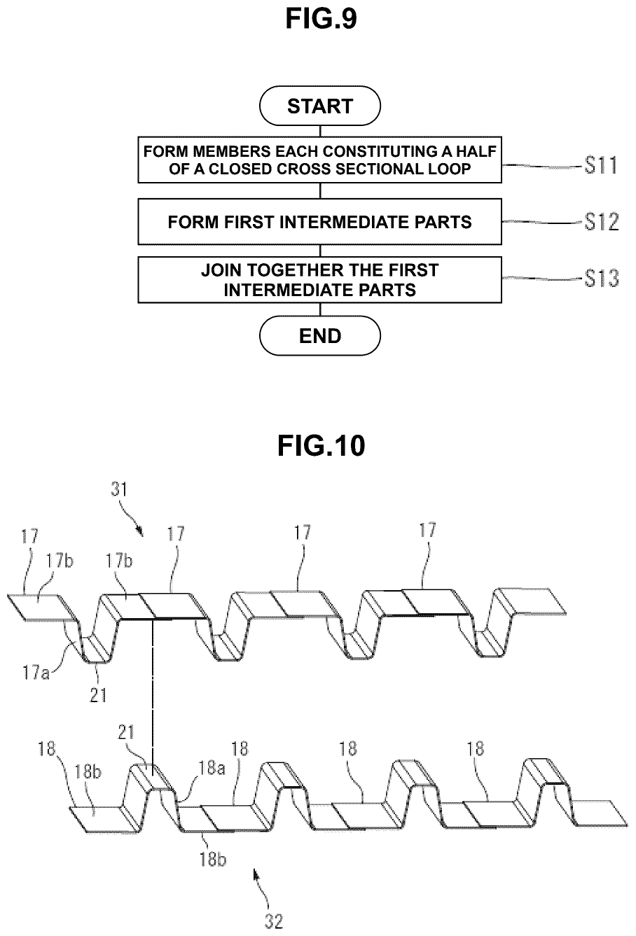

The second manufacturing method is carried out as shown in the flow chart of FIG. 9. First, as shown in step S11 of the flow chart of FIG. 9, the first member constituting a half of a closed cross-sectional profile 17 and the second member constituting a half of a closed cross-sectional profile 18 are respectively formed. The first member constituting a half of a closed cross-sectional profile 17 and the second member constituting a half of a closed cross-sectional profile 18 are formed as shown in FIG. 8A. Next, as shown in the first intermediate part formation step S12 of the flow chart and in FIG. 10, the upper first intermediate part 31 and the lower first intermediate part 32 are formed. At this time, a plurality of first members each constituting a half of a closed cross-sectional profile 17 are lined up in the vehicle front-rear direction, and adjacent first members each constituting a half of a closed cross-sectional profile 17 are welded together to form an upper first intermediate part 31, which serves as an intermediate part. Moreover, a plurality of second members each constituting a half of a closed cross-sectional profile 18 are lined up in the vehicle front-rear direction, and adjacent second members each constituting a half of a closed cross-sectional profile 18 are welded together to form a lower first intermediate part 32, which serves as an intermediate part. The upper first intermediate part 31 and the lower first intermediate part 32 do not have a closed cross-sectional profile.

Then, the upper first intermediate part 31 and the lower first intermediate part 32 are combined in an orientation in which the convex directions of the hat portions are opposite to each other, and the top portion of the hat portion of one member constituting a half of a closed cross-sectional profile is overlapped and joined to the flange portion of the other member constituting a half of a closed cross-sectional profile (impact absorbing member forming step S13). At this time, the top portion 21 of the hat portion 17a of the first intermediate part 31 of the upper divided body is welded to the flange portion 18b of the lower first intermediate part 32 by spot welding, and the flange portion 17b of the upper first intermediate part 31 is welded to the top portion 21 of the hat portion 18a of the lower first intermediate part 32 by spot welding. In this manner, the upper first intermediate part 31 and the lower first intermediate part 32, which are intermediate parts, are joined together to complete an impact absorbing member 6 having an elongated shape.

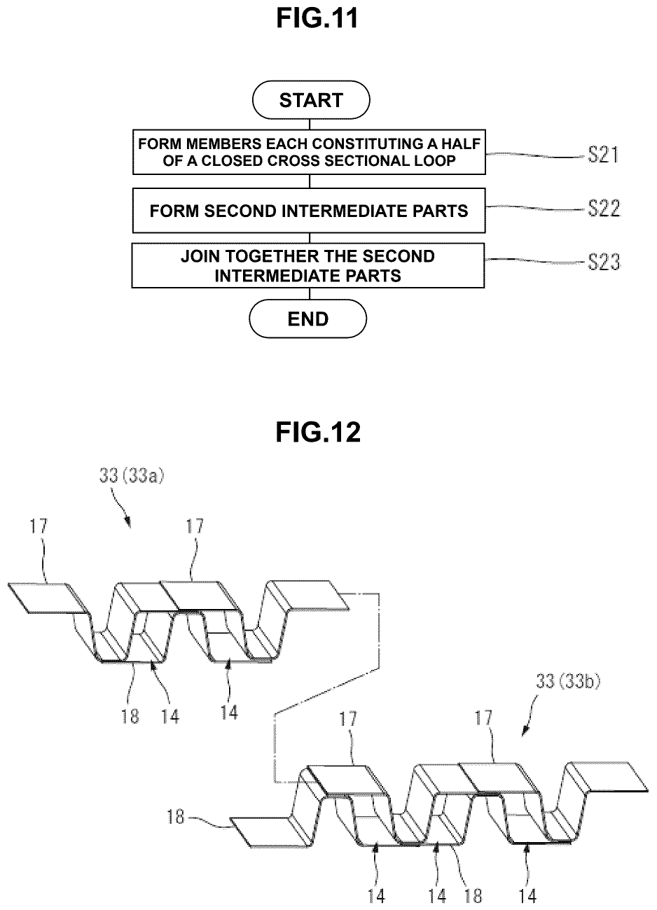

The third manufacturing method is carried out as shown in the flow chart of FIG. 11. First, as shown in step S21 of the flow chart of FIG. 11, the first member constituting a half of a closed cross-sectional profile 17 and the second member constituting a half of a closed cross-sectional profile 18 are respectively formed. The first member constituting a half of a closed cross-sectional profile 17 and the second member constituting a half of a closed cross-sectional profile 18 are formed as shown in FIG. 8A. Next, as shown in FIG. 12, the first member constituting a half of a closed cross-sectional profile 17 and the second member constituting a half of a closed cross-sectional profile 18 are combined to have a posture in which the convex directions of the hat portions are opposite to each other, and the top portion of the hat portion of one member constituting a half of a closed cross-sectional profile is overlapped and joined to the flange portion of the other member constituting a half of a closed cross-sectional profile to form at least two second intermediate parts 33 (second intermediate part formation step S22). The second intermediate part 33 has closed cross-sectional profiles. FIG. 12 shows a second intermediate part 33a and a second intermediate part 33b. Thereafter, the second intermediate part 33a and the second intermediate part 33b are lined up in the front-rear direction and welded to each other (impact absorbing member forming step S23). In this manner, the second intermediate part 33a and the second intermediate part 33b, which are intermediate parts, are joined to each other, whereby an impact absorbing member 6 having an elongated shape is completed.

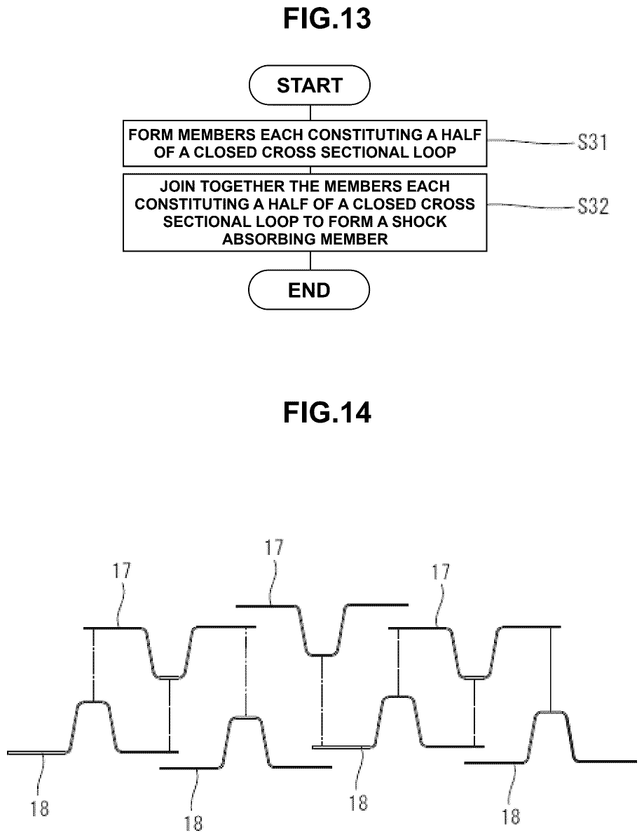

The fourth manufacturing method is carried out as shown in the flow chart of FIG. 13. First, as shown in step S31 of the flow chart of FIG. 13, the first member constituting a half of a closed cross-sectional profile 17 and the second member constituting a half of a closed cross-sectional profile 18 are respectively formed. The first member constituting a half of a closed cross-sectional profile 17 and the second member constituting a half of a closed cross-sectional profile 18 are formed as shown in FIG. 8A. Next, as shown in step S32 of the flow chart and in FIG. 14, the impact absorbing member 6 is formed. At this time, the members each constituting a half of a closed cross-sectional profile constituting the impact absorbing member 6 are combined in a posture in which the convex directions of adjacent hat portions are opposite to each other, while the members each constituting a half of a closed cross-sectional profile are not joined to each other. The top portion of the hat portion of the member constituting a half of a closed cross-sectional profile is then overlapped and joined to the flange portion of the adjacent member constituting a half of a closed cross-sectional profile in the opposite orientation to this member constituting a half of a closed cross-sectional profile, thereby completing an impact absorbing member 6 having an elongated shape. The top portion of the hat portion of the member constituting a half of a closed cross-sectional profile may be joined to the flange portions of the adjacent members each constituting a half of a closed cross-sectional profile on both sides in the opposite orientation to this member constituting a half of a closed cross-sectional profile such that three sheets are joined.

### Manufacturing Method of the Side Sill

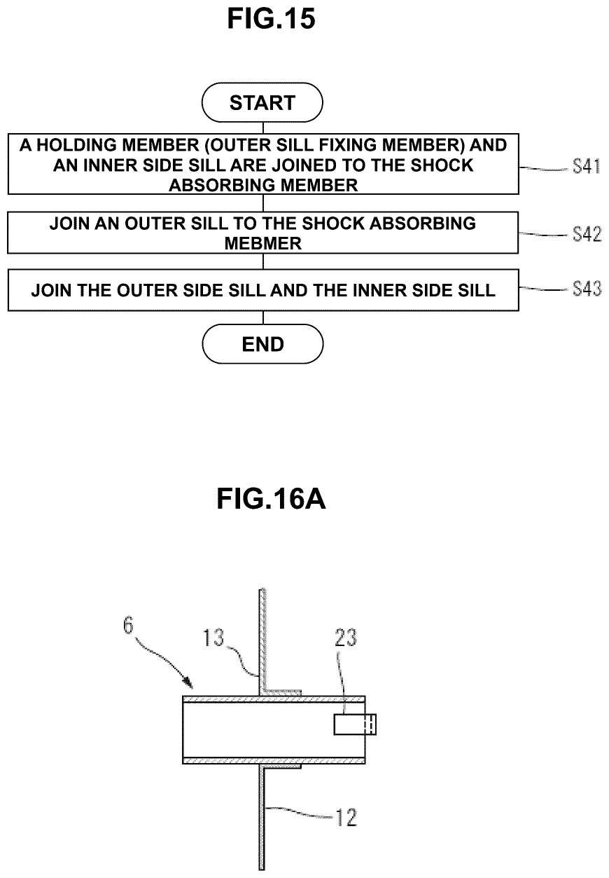

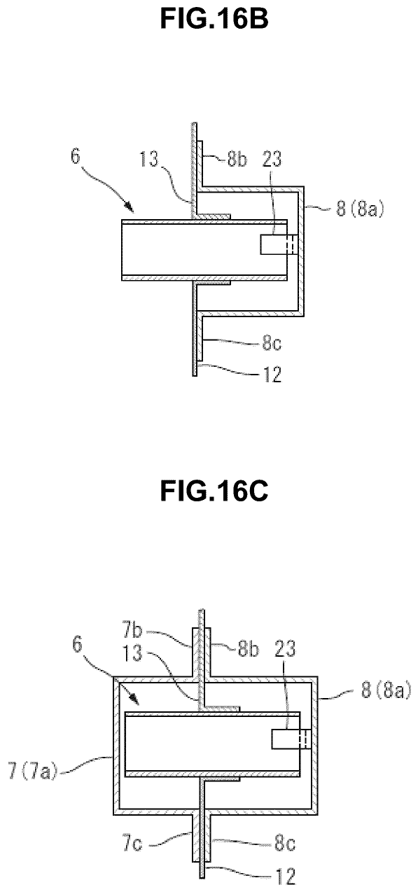

In order to manufacture a side sill 4 having the impact absorbing member 6 formed in an elongated shape, the method carries out steps as shown in the flow chart of FIG. 15. First, as shown in FIG. 16A, the holding member 12 and the inner center pillar coupling segment 13 are joined to the impact absorbing member 6 (step S41). When the (outer sill) fixing member 23 is welded to the first and second members each constituting a half of a closed cross-sectional profile 17, 18 of the impact absorbing member 6, such welding is carried out in this step.

Next, as shown in FIG. 16B, the outer side sill 8 is joined to the impact absorbing member 6 (step S42). This joining is performed by welding the outer side sill 8 to the (outer sill) fixing member 23. Then, as shown in FIG. 16C, the outer side sill 8 to which the impact absorbing member 6 is joined and the inner side sill 7 are joined together (step S43). Such joining is performed by overlapping the upper flange 7b and the lower flange 7c of the inner side sill 7 with the upper flange 8b and the lower flange 8c of the outer side sill 8, and spot welding them together. When such joining is performed, the holding member 12 and the inner center pillar coupling segment 13 are sandwiched by the flanges, and such members are also joined to the flanges at the same time. The outer side sill 8 is joined to the inner side sill 7, whereby a side sill 4 is completed. At this time, the inner center pillar coupling segment 13 is also joined to the lower end of the inner side sill 7.

### Another Manufacturing Method of the Side Sill

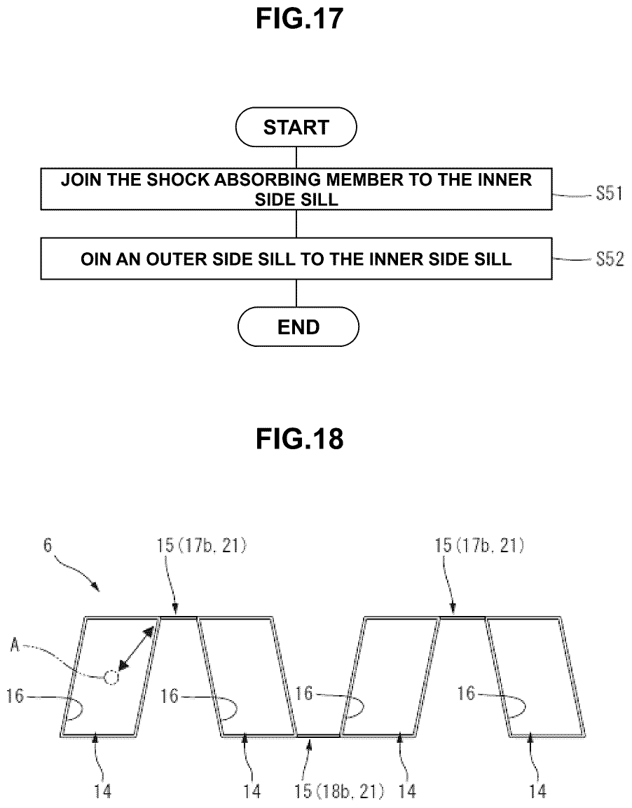

The side sill 4 having the impact absorbing member 6 formed in an elongated shape can be manufactured according to the process shown in the flow chart of FIG. 17. In the manufacturing method of this side sill 4, first, in step S51, the impact absorbing member 6 is joined to the inner side sill 7. In this case, an inner sill fixing member (not illustrated), which is commensurate with the outer sill fixing member 23, is provided in advance on the impact absorbing member 6 such that the inner sill fixing member is welded to the inner side sill 7 in step S51. Next, in step S52, the outer side sill 8 is welded to the inner side sill 7. In this step S52, the holding member 12 and the inner center pillar coupling segment 13 are sandwiched between the upper flange 7b and lower flange 7c of the inner side sill 7 and the upper flange 8b and lower flange 8c of the outer side sill 8, and these components are spot welded simultaneously. The outer side sill 8 is joined to the inner side sill 7, whereby a side sill 4 is completed.

By using this manufacturing method and joining the impact absorbing member 6 to the inner side sill 7 side, it becomes easy to carry out positioning such that the load can be transmitted to a rigid member (cross member) on the floor side.

Advantageous Effects of this Embodiment

As shown in FIG. 18, the impact absorbing member 6 according to this embodiment includes: at least two hollow bodies 14 lined up at predetermined intervals in the vehicle front-rear direction with shapes of the closed cross-sectional profiles 16 extending in the vehicle width direction; and connecting segments 15 (flange portions 17b, 18b and top portion 21) that connect adjacent hollow bodies 14 to each other at positions where there is an offset between the adjacent hollow bodies 14 in the up-down direction (positions where there is a difference in the up-down direction). When a plurality of connecting segments 15 are provided in the vehicle front-rear direction, the positions of the connecting segments 15 in the up-down direction are alternately distributed in the vehicle front-rear direction. The impact absorbing member 6 is configured such that the connecting segments 15 (flange portions 17b, 18b) are offset in the up-down direction relative to the centroid A of the hollow body 14 when viewed from the side, and are far away from the centroid A. Therefore, compared with the case where the connecting segment 15 is located at the same height as the centroid A of the hollow body 14, the second moment of area increases.

Furthermore, by having the pair of hollow bodies 14, 14 have the above-mentioned widening shape, the strength of the connecting segment 15 can be further increased, so that it is possible to firmly absorb the collision load at a biased position of the connecting segment 15 and crush the impact absorbing member 6 from the outer side/end. Since the hollow bodies 14, 14 are alternately overlapped in the front-rear direction, the impact can be absorbed not only in the case of a side impact load from directly to the side, but also in the case of an input from any inclination such as upward, downward, forward or rearward.

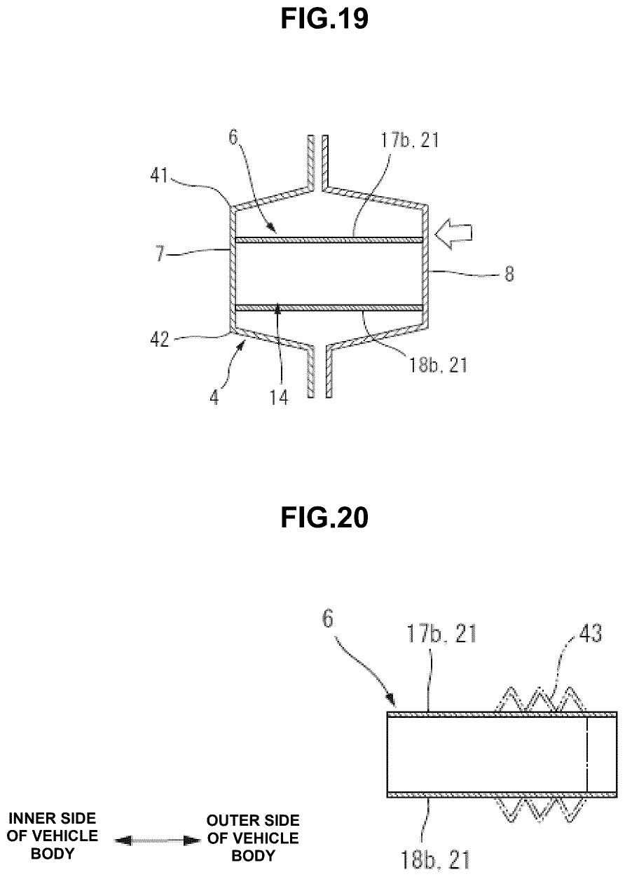

Moreover, since the connecting segment 15 is offset in the up-down direction relative to the centroid A of the hollow body 14 as shown in FIG. 18, the connecting segment 15 comes closer to the upper corner 41 and the lower corner 42 of the inner side sill 7 shown in FIG. 19. The upper corners 41 and the lower corners 42 of the inner side sill 7 are corners, and therefore have higher stiffness in the vehicle width direction than other portions, as compared to flat portions.

Therefore, compared to a case where the connecting segment 15 is not offset in the up-down direction, during a collision in which an impact load is applied to the side sill 4 from the side of the vehicle body, i.e., during a side collision, the vertical surface of the inner side sill 7 is not likely to bend, and as shown by the dotted line in FIG. 20, deformation 43 gradually progresses from the end on the vehicle outer side toward the vehicle inner side, causing the impact absorbing member 6 to crush. As a result, the absorbing amount of impact energy is increased.

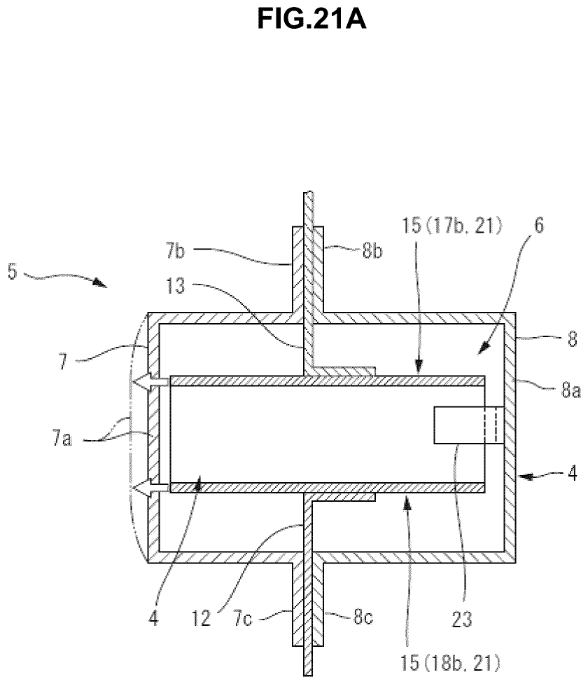

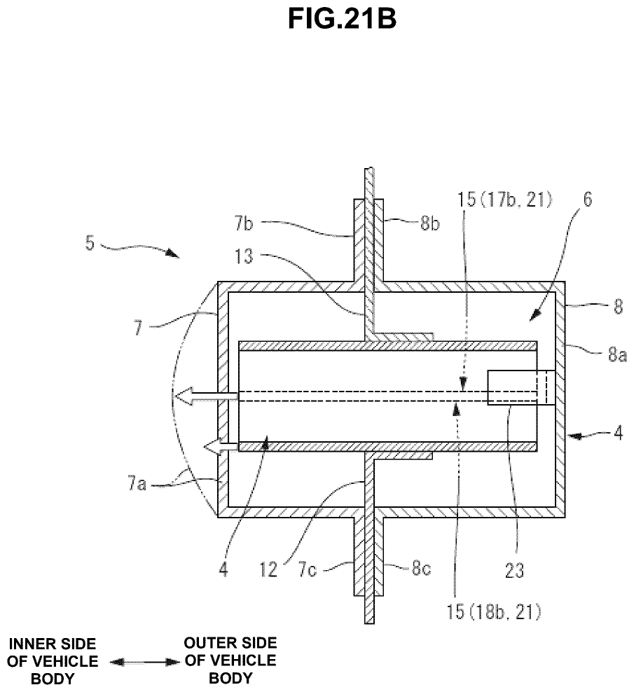

Moreover, since the connecting segments 15 are offset in the up-down direction from the centroid A of the hollow body 14, the upper surface/lower surface of the hollow body 14 and the upper and lower connecting segments 15 are closer to the upper and lower corners of the inner side sill 7. The upper and lower corners of the inner side sill 7 have high stiffness/strength and the side impact load is distributed in the up-down direction, and therefore the inner side sill 7 withstands the side impact load such that movement of the impact absorbing member 6 toward the inner side of the vehicle is suppressed (see FIG. 21A). Arrows shown in FIG. 21A indicate the amount of movement. As a result, the impact absorbing member 6 collapses from the end on the vehicle outer side toward the vehicle inner side, which helps to increase the amount of shock energy absorbed. Furthermore, although not illustrated, the impact absorbing member 6 also comes close to the floor below and the cross member above, and therefore movement of the impact absorbing member 6 toward the vehicle cabin is further suppressed. Meanwhile, when the connecting segment 15 is not offset in the up-down direction but is located in the center as shown in FIG. 21B, the inner side sill 7 undergoes out-of-plane deformation during a side collision such that the side surface extending in the up-down direction deforms toward the vehicle inner side, as shown by the dotted line in FIG. 21B. As a result, the impact absorbing member 6 moves toward the inner side of the vehicle cabin, or tilts within the side sill 4, making the impact absorbing member 6 unstable in its posture, and it is unable to proceed from the end on the vehicle outer side toward the vehicle inner side and be crushed.

The hollow body 14 and the connecting segment 15 of the impact absorbing member 6 according to this embodiment are formed by combining a pair of members each constituting a half of a closed cross-sectional profile (first member constituting a half of a closed cross-sectional profile 17 and second member constituting a half of a closed cross-sectional profile 18). The member constituting a half of a closed cross-sectional profile is constituted by: a hat portion 17a, 18a formed to have a cross-section having a shape of a recess; and a pair of flange portions 17b, 18b protruding from both ends of the hat portion 17a, 18a in the longitudinal direction of the impact absorbing member 6. The pair of members each constituting a half of a closed cross-sectional profile are joined to each other with the convex directions of the hat portions 17a, 18a being opposite in the up-down direction and with the top portion 21 of the hat portion 17a, 18a overlapping with the flange portions 17b, 18b on one sides. A closed cross-sectional profile 16 is formed by: side portions (inclined walls 22), which face each other, of the hat portions 17a, 18a of the pair of members each constituting a half of a closed cross-sectional profile; and flange portions 17b, 18b, which face each other.

Therefore, the smallest unit of material to be press-formed in manufacturing the impact absorbing member 6 is a member constituting a half of a closed cross-sectional profile 17, 18 having one hat portion 17a, 18a, which makes it easy to press-form a steel plate. This is because the inclined wall 22 prevents undercuts from being formed during press-forming. Moreover, in this press-forming, a part having a shape in which two or more hat portions, for example, two members each constituting a half of a closed cross-sectional profile 17, are lined up in the vehicle front-rear direction can be the minimum unit. Furthermore, in this embodiment, as shown in FIG. 3B, multiple members each constituting a half of a closed cross-sectional profile are combined in the vehicle front-rear direction such that the flange portions 17b, 18b (connecting segments 15) are distributed at upper and lower positions, and therefore the number of steel plates, of the top portion 21 and the flange portions 17b, 18b, on the spot welding portion is three. This increases the reliability of the spot welding.

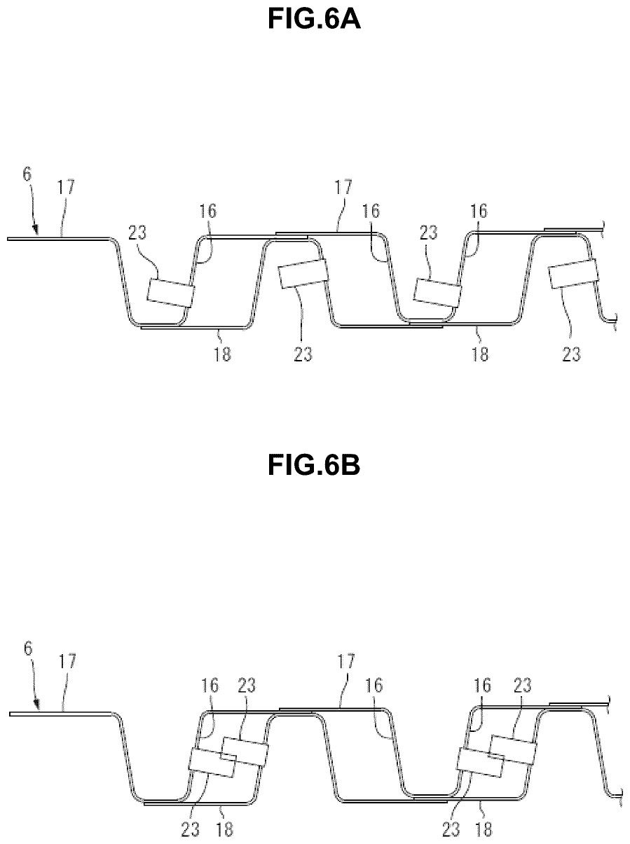

The automobile side sill structure 5 according to this embodiment includes: an outer sill fixing member 23 that protrudes outward from the closed cross-sectional profile 16 of the impact absorbing member 6 as shown in FIG. 6A; and an outer side sill 8 that is joined to the outer sill fixing member 23 while surrounding the impact absorbing member 6 from the vehicle outer side as shown in FIG. 2. When the outer sill fixing member 23 extends toward the inner side of the closed cross-sectional profile 16 as shown in FIG. 6B, adjacent outer sill fixing members 23 interfere with each other. Therefore, in this case, in order to avoid interference between the outer sill fixing members 23, the closed cross-sectional profile 16 has to be expanded in the vehicle front-rear direction to a size that prevents the outer sill fixing members 23 from interfering with each other. This reduces the number of closed cross-sectional profiles 16 in the entire impact absorbing member 6, and reduces the amount of energy absorbed by the impact absorbing member 6 during a side collision. However, since the outer sill fixing member 23 in this embodiment extends outward from the closed cross-sectional profile 16 as shown in FIG. 6A, interference between the outer sill fixing members 23 can be prevented without lowering the amount of energy absorbed by the impact absorbing member 6 during a side collision.

As shown in FIG. 2, the automobile side sill structure 5 according to this embodiment includes: an inner side sill 7 that is surrounded by the impact absorbing member 6 and arranged on the vehicle inner side thereof; an outer side sill 8 that surrounds the impact absorbing member 6 and arranged on the vehicle outer side thereof; and a holding member 12 that supports the impact absorbing member 6 from below. Therefore, the impact absorbing member 6 can be held in a stable state inside the side sill 4, and therefore when an impact is applied to the side sill 4 from the side of the vehicle body, the impact absorbing member 6 does not tilt or roll but the upper and lower surfaces of the impact absorbing member 6 deform so as to buckle and absorb the impact.

Moreover, since the impact absorbing member 6 can be held without being joined to the inner side sill 7, manufacturing is facilitated.

Therefore, it is possible to easily achieve a side sill structure 5 that is strong against side collisions.

In the automobile side sill structure 5 according to this embodiment, the inner center pillar 3 is joined to the upper surface of the impact absorbing member 6 as shown in FIG. 2. Therefore, the collision energy can be transmitted from the impact absorbing member 6 to the inner center pillar 3, thereby obtaining a side sill structure 5 that is even stronger against side collisions.

The impact absorbing member 6 according to this embodiment can be joined to the inner side sill 7, although not illustrated. That is, by firmly joining the impact absorbing member 6 to the inner side sill 7 with an adhesive or the like, it is possible to achieve a side sill structure 5 with further improved strength.

An impact absorbing member 6 can be manufactured by combining a plurality of members each constituting a half of a closed cross-sectional profile, each of which is a smallest constituting component by adopting as a manufacturing method of the impact absorbing member 6, a method including: a step S1 of forming a plurality of members each constituting a half of a closed cross-sectional profile (first member constituting a half of a closed cross-sectional profile 17 and second member constituting a half of a closed cross-sectional profile 18); a step S2 of forming a structure configuring a closed cross-sectional profile 20; and a step S3 of combining the plurality of structures each configuring a closed cross-sectional profile 20 to form an impact absorbing member 6 having a long length, as shown in FIGS. 7 and 8. Therefore, it is possible to manufacture impact absorbing members 6 in various shapes and lengths. Moreover, when there is a defective product, the replacement can be carried out on one member constituting a half of a closed cross-sectional profile basis, and therefore the yield rate is increased. Furthermore, since the press die for molding the steel plate to form into a predetermined shape can be small, it is possible to keep the manufacturing costs of equipments required for production low.

The welding performed in manufacturing the impact absorbing member 6 becomes easier when, as shown in FIGS. 9-12, adopting a manufacturing method of the impact absorbing member 6 including: a first intermediate part formation step S11 and a second intermediate part formation step S21 of forming an intermediate part (upper first intermediate part 31, lower first intermediate part 32, and second intermediate part 33) by joining a plurality of members each constituting a half of a closed cross-sectional profile together; and impact absorbing member formation steps S13 and S23 of form an impact absorbing member 6 having a long length by joining the plurality of intermediate parts together. That is, when manufacturing the impact absorbing member 6 by lining up a required number of small parts, a positioning jig is required for each small part, which requires a large number of positioning pins. However, when the impact absorbing member 6 is manufactured by welding a plurality of intermediate parts together as in this embodiment, the number of positioning jigs and positioning pins is reduced, making the welding easier as described above.

An impact absorbing member 6 having a long length can be formed in the next step after forming the members each constituting a half of a closed cross-sectional profile, without undergoing the intermediate part forming step, when, as shown in FIGS. 13 and 14, adopting a manufacturing method of the impact absorbing member 6 including: a step S31 of forming a plurality of members each constituting a half of a closed cross-sectional profile (first member constituting a half of a closed cross-sectional profile 17 and second member constituting a half of a closed cross-sectional profile 18); and a step S32 of forming an impact absorbing member 6 having a long length. This eliminates the need for welding equipment, such as welding jigs, for forming the intermediate parts, and allows the impact absorbing member 6 to be manufactured at low cost. Moreover, productivity is improved since the step of forming the intermediate part is omitted.

The manufacturing method of the side sill 4 according to this embodiment is, as shown in FIG. 15, carried out by: a step S42 of joining the impact absorbing member 6 to the outer side sill 8; and a step S43 of joining the outer side sill 8 to which the impact absorbing member 6 has been joined and the inner side sill 7. Therefore, the inner side sill 7 can be welded to the automobile body frame 1 in advance and supported by the body frame 1, and therefore positioning can be easily carried out when welding the impact absorbing member 6 and the outer side sill 8 to the inner side sill 7. As a result, the operation of mounting the side sill 4 to the vehicle body is facilitated.

### Second Embodiment

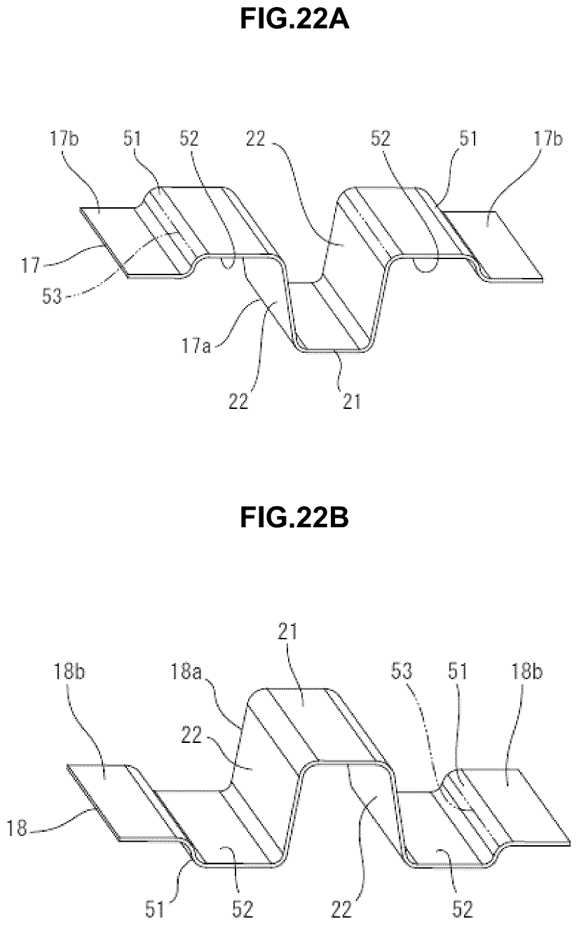

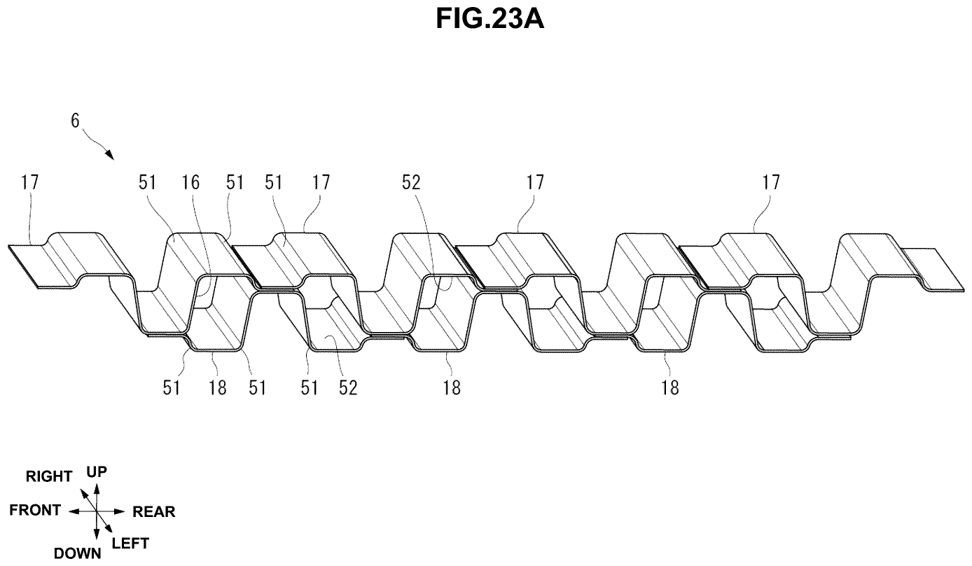

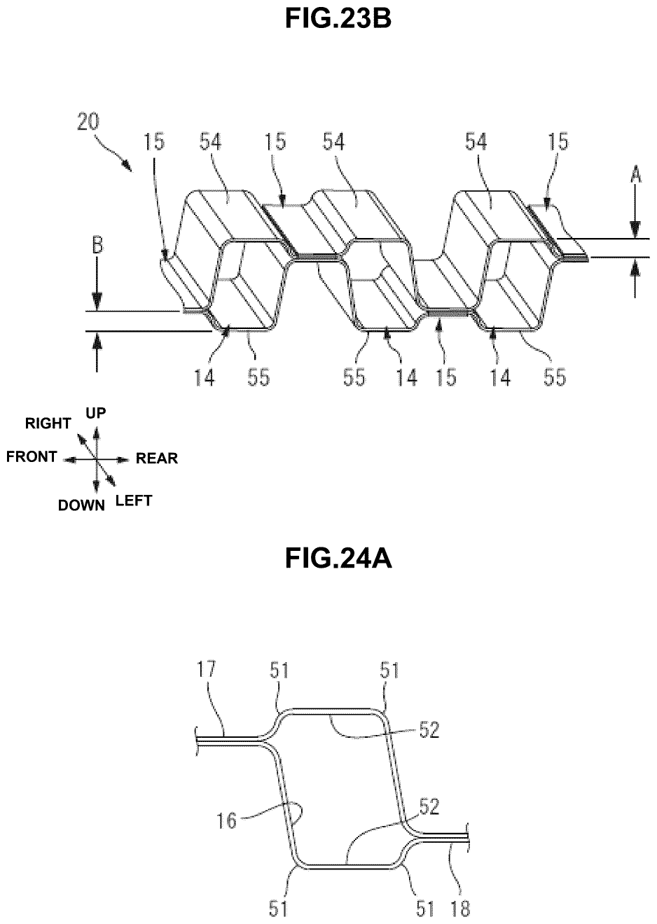

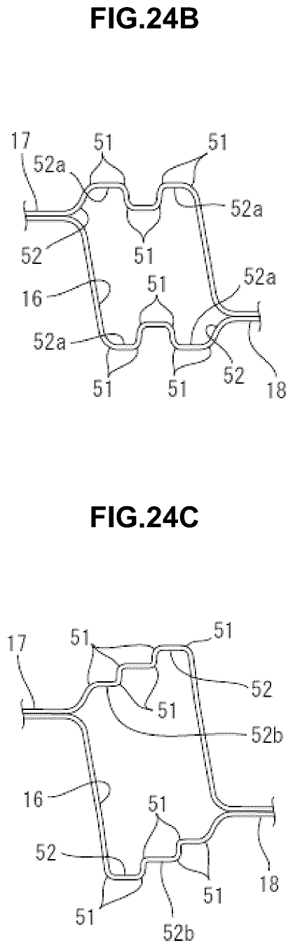

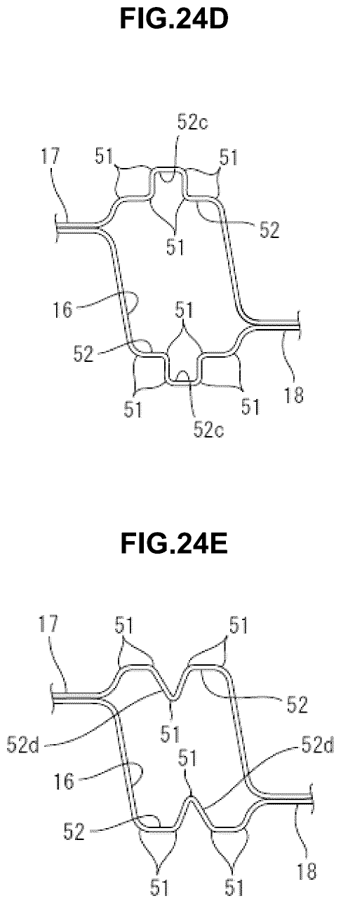

An impact absorbing member 6 can be configured as shown in FIGS. 22A-24E. FIG. 22A shows a perspective view illustrating a first member constituting a half of a closed cross-sectional profile 17, and FIG. 22B shows a perspective view illustrating a second member constituting a half of a closed cross-sectional profile 18. FIG. 23A shows a perspective view illustrating another embodiment of the impact absorbing member, and FIG. 23B shows a perspective view illustrating upper and lower surfaces of the hollow bodies and positions of connecting segments in the up-down direction. FIG. 24A shows an example in which two corners are provided on each of the upper and lower sides of the closed cross-sectional profile 16, FIGS. 24B-24D show examples in which six corners are provided on each of the upper and lower sides of the closed cross-sectional profile 16, and FIG. 24E shows an example in which five corners are provided on each of the upper and lower sides of the closed cross-sectional profile 16. In FIGS. 22A-24E, components that are the same as or commensurate with those described with reference to FIGS. 1-21 are given the same reference signs and detailed descriptions thereof will be omitted as appropriate.

In the first and second members each constituting a half of a closed cross-sectional profile 17, 18 shown in FIGS. 22A and 22B, a recess 52 having two corners 51, 51 is formed between the hat portions 17a, 18a and the flange portions 17b, 18b by press-forming. The recess 52 having the corners 51 is formed by press-forming a base end portion (an end portion on the hat portion 17a, 18a side) of the flange portion 17b, 18b in a direction in which the height of the hat portion 17a, 18a increases. The corners 51 located on both sides of the recess 52 have ridges 53 extending in the vehicle width direction. Hereinafter, a corner 51 having a ridge 53 will be simply referred to as a “corner ridge 51.”

When the first member constituting a half of a closed cross-sectional profile 17 and the second member constituting a half of a closed cross-sectional profile 18 having such corner ridges 51 are combined, two corner ridges 51 are provided on each of the upper and lower sides of the closed cross-sectional profile 16 as shown in FIG. 23A. As shown in FIG. 23B, the structure configuring a closed cross-sectional profile 20 according to this embodiment has a connecting segment 15 lined up with the upper surface 54 or the lower surface 55 of the hollow body 14. The upper surface 54 and the connecting segment 15 are offset by a distance A in the up-down direction. The lower surface 55 and the connecting segment 15 are offset by a distance B in the up-down direction. The upper surface 54, the lower surface 55, and the connecting segment 15 are arranged in the longitudinal direction along the inner side sill 7 while being offset in the up-down direction in this manner.

The impact absorbing member 6 to which the corner ridges 51 are added in this manner has a larger energy absorption capacity than the impact absorbing member 6 in accordance with the first embodiment. This is because the strength of the corner ridge 51 is high, and therefore the energy required to buckle it increases. That is, simply by forming the recesses 52 during press-forming of the first member constituting a half of a closed cross-sectional profile 17 and the second member constituting a half of a closed cross-sectional profile 18, the amount of energy absorbed by the impact absorbing member 6 can be increased.

Although not illustrated, the corner ridge 51 may be provided on only one of the upper and lower sides of the closed cross-sectional profile 16.

The corner ridge 51 can be provided on the first member constituting a half of a closed cross-sectional profile 17 and the second member constituting a half of a closed cross-sectional profile 18 as shown in FIGS. 24A-24E. That is, as shown in FIG. 24A, the corner ridge 51 can be provided at both ends of the upper and lower sides of the closed cross-sectional profile 16 by forming the recess 52 into a concave shape and forming the upper and lower sides such that the closed cross-sectional profile 16 is expanded in the up-down direction.

Moreover, as shown in FIG. 24B, the corner ridges 51 can be provided at six locations on each of the upper and lower sides of the closed cross-sectional profile 16 by adding two small second recesses 52a and press-forming the recess 52 such that the closed cross-sectional profile 16 is expanded in the up-down direction at two locations. By such press-forming, the central portion of the upper and lower sides of the closed cross-sectional profile 16 is recessed inwardly of the closed cross-sectional profile 16 so as to have a rectangular cross-section.

FIG. 24C shows an example in which the upper and lower sides of the closed cross-sectional profile 16 are formed in a stepped shape, with six corner ridges 51 provided on each of the upper and lower sides. A stepped-shape portion 52b is added to one of the recesses 52 shown in FIG. 24C (one on the flange portion side), and upper and lower sides are formed such that the closed cross-sectional profile 16 is expanded in the up-down direction.

FIG. 24D shows an example in which the central portions of the upper and lower sides of the closed cross-sectional profile 16 are protruded outwardly of the closed cross-sectional profile 16 to have a rectangular cross-section, providing six corner ridges 51 on each of the upper and lower sides. On the bottom surface of the recess 52 shown in FIG. 24D, there is a smaller minuscule recess 52c formed by press-forming, and upper and lower sides are formed such that the closed cross-sectional profile 16 is expanded in the up-down direction.

FIG. 24E shows an example in which the central portions of the upper and lower sides of the closed cross-sectional profile 16 are recessed in a V-shape in cross-section, and five corner ridges 51 are provided on each of the upper and lower sides. A raised portion 52d is formed in the center of the bottom surface of the recess 52 shown in FIG. 24E by press-forming such that this portion is raised. In the example shown in FIG. 24E as well, the upper and lower sides are formed such that the closed cross-sectional profile 16 is expanded in the up-down direction.

### Third Embodiment

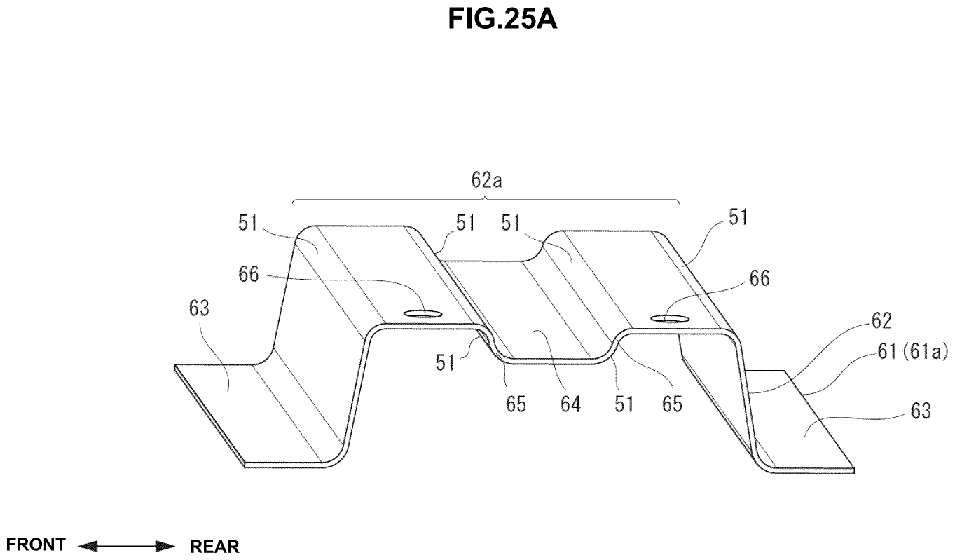

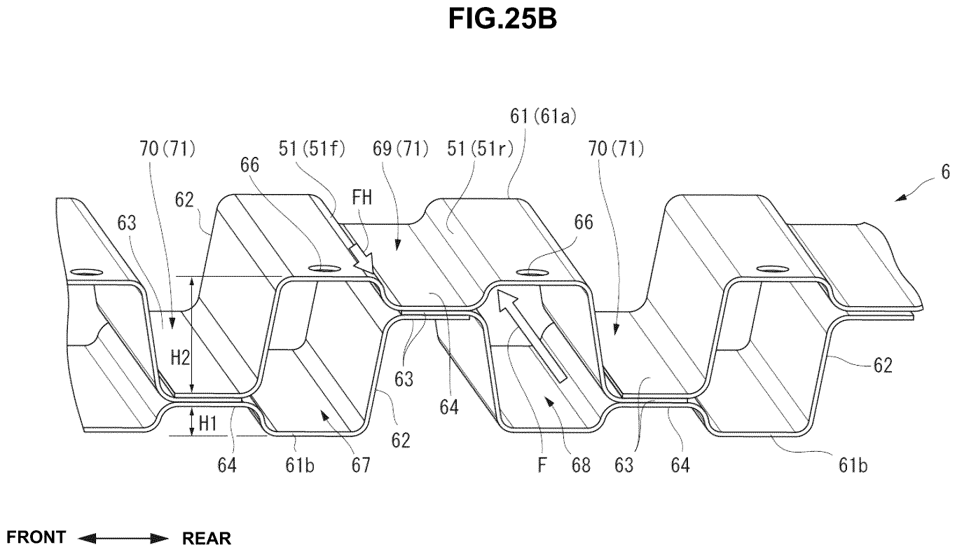

The impact absorbing member may be constructed as shown in FIGS. 25A and 25B. In FIGS. 25A and 25B, components that are the same as or commensurate with those described with reference to FIGS. 1-24 are given the same reference signs and detailed descriptions thereof will be omitted as appropriate.

A member constituting a half of a closed cross-sectional profile 61 shown in FIG. 25A is formed to have a hat-shaped cross-section by press-forming a steel plate using a die (not illustrated). That is, the member constituting a half of a closed cross-sectional profile 61 has flange portions 63 one on each side of a hat portion 62. In comparison with the first and second members each constituting a half of a closed cross-sectional profile 17, 18 shown in FIGS. 22A and 22B, this member constituting a half of a closed cross-sectional profile 61 has a top portion 62a of the hat portion 62 that is longer in the front-rear direction. A recessed portion 64 is formed in the central portion of the top portion 62a in the front-rear direction, where a part of the top portion 62a is recessed toward the inner side of the hat portion 62.

By forming the recessed portion 64 in the top portion 62a of the hat portion 62, stepped portions 65 are formed on two locations on the top portion 62a, and four corner ridges 51 are formed. Therefore, six corner ridges 51 are formed on one hat portion 62.

At the front and rear parts on the top portion 62a, which sandwich the recessed portion 64, there are formed weakened portions 66 each constituted by a through hole. The weakened portion 66, the details of which will be described later, is a functional part provided for improving the impact absorbing performance. The weakened portion 66 will be described later.

To form the impact absorbing member 6 using such a member constituting a half of a closed cross-sectional profile 61, two members each constituting a half of a closed cross-sectional profile having the same shape as the member constituting a half of a closed cross-sectional profile 61 except that there is no weakened portion 66 are created, and then the members each constituting a half of a closed cross-sectional profile are stacked and joined in a position inverted in the up-down direction, as shown in FIG. 25B. For convenience, the member constituting a half of a closed cross-sectional profile having the weakened portion 66 is referred to as an upper member constituting a half of a closed cross-sectional profile 61a, and the member constituting a half of a closed cross-sectional profile not having the weakened portion 66 is referred to as a lower member constituting a half of a closed cross-sectional profile 61b. The upper member constituting a half of a closed cross-sectional profile 61a shown in FIG. 25B is used in a posture in which the hat portion 62 is convex upward, and the lower member constituting a half of a closed cross-sectional profile 61b is used in a posture in which the hat portion 62 is convex downward.

The rear flange portion 63 of the lower member constituting a half of a closed cross-sectional profile 61b located at the front side and the front flange portion 63 of the lower member constituting a half of a closed cross-sectional profile 61b located at the rear side are overlapped from below in the recessed portion 64 of the upper member constituting a half of a closed cross-sectional profile 61a. The recessed portion 64 of the lower member constituting a half of a closed cross-sectional profile-portion 61b is overlapped by the rear flange portion 63 of the upper member constituting a half of a closed cross-sectional profile-portion 61a located at the front side and the front flange portion 63 of the upper member constituting a half of a closed cross-sectional profile-portion 61a located at the rear side. By performing spot welding at such overlapping portions, the upper member constituting a half of a closed cross-sectional profile 61a and the lower member constituting a half of a closed cross-sectional profile 61b are joined together to form an impact absorbing member 6. In this impact absorbing member 6, a front hollow body 67 and a rear hollow body 68 are formed by one upper member constituting a half of a closed cross-sectional profile 61a and two lower members each constituting a half of a closed cross-sectional profile 61b. The front hollow body 67 and the rear hollow body 68 are formed to have the above-mentioned widening shape when viewed in the vehicle width direction.

In the impact absorbing member 6 shown in FIG. 25B, the flange portions 63 of the members each constituting a half of a closed cross-sectional profile lined up in the front-rear direction on the opposite upper and lower sides are overlapped on the bottom surface of the recessed portion 64 (inner surface of the hat portion 62). The depth H1 of the recessed portion 64 is shallower than the height H2 of the hat portion 62 relative to the flange portion 63. That is, H1<H2.

The recessed portion 64 of the upper member constituting a half of a closed cross-sectional profile 61a constitutes a part of an upper connecting segment 69 that connects the upper ends of the front hollow body 67 and the rear hollow body 68 together. The recessed portion 64 of the lower member constituting a half of a closed cross-sectional profile 61b constitutes a part of a lower connecting segment 70 that connects the lower ends of the front hollow body 67 and the rear hollow body 68 together.

The upper connecting segment 69 and the lower connecting segment 70 of the impact absorbing member shown in FIG. 25B are configured by joining the flange portion 63 to the bottom surface of the recessed portion 64, that is, to the inner side of the hat portion 62. In the following, the upper connecting segment 69 and the lower connecting segment 70 to which the flange portion 63 is joined on the inner side of the hat portion 62 will be simply referred to as the “connecting segment 71 of inner connecting type.”

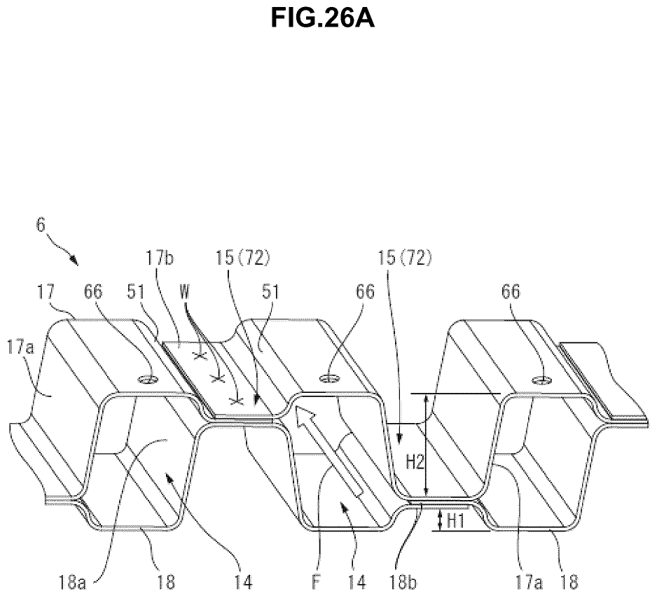

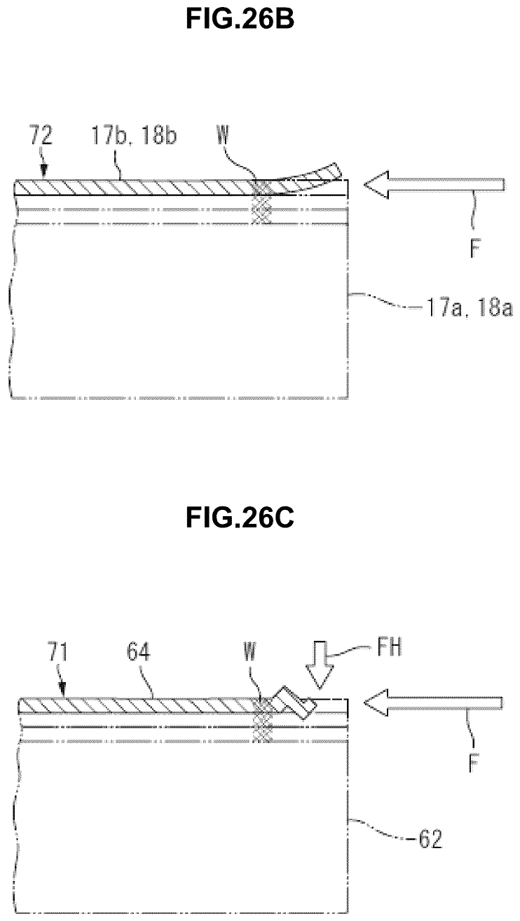

The impact absorbing member 6 shown in FIG. 25B has higher impact energy absorbing performance than the impact absorbing member 6 shown in FIGS. 23A and 23B in which the weakened portion 66 is provided. The reason is as follows. In the impact absorbing member 6 shown in FIGS. 23A and 23B, the connecting segment 15 corresponds to the above-mentioned recessed portion, as shown in FIG. 26A. The connecting segment 15 shown in FIG. 26A has flange portions 17b, 18b joined to the outer sides of hat portions 17a, 18a. In the following, the connecting segment 15 in which the flange portions 17b, 18b are joined to the outer side of the hat portions 17a, 18a will be simply referred to as the “connecting segment 72 of outer connecting type.”

In both the impact absorbing member 6 shown in FIG. 25B and the impact absorbing member 6 shown in FIG. 26A, the depth H1 of the recessed portion is shallower than the height H2 of the hat portion relative to the flange portion (H1<H2). Therefore, when part of the load of a pole collision acts on the corner ridge 51 on the side where the recess is shallower as shown by arrow F in the figure, this load F acts directly on the recessed portion. This load F acts on the connecting segment 72 of outer connecting type in the impact absorbing member 6 shown in FIG. 26A, and acts on the connecting segment 71 of inner connecting type in the impact absorbing member 6 shown in FIG. 25B.

When the aforementioned load F is acted on the connecting segment 72 of outer connecting type, the flange portions 17b, 18b are turned up from the spot welded portion W toward the top side of the recessed portion as shown in FIG. 26B. It has been found that if a portion of the flange 17b, 18b is turned up in this manner, the amount of impact energy absorbed decreases. Meanwhile, when part of the load of a pole collision acts on one corner ridge 51r adjacent on the rear side of the connecting segment 71 (recessed portion 64) of inner connecting type shown in FIG. 25B, as shown by arrow F in the figure, since this corner ridge 51r is connected to the other corner ridge 51f via the recessed portion 64, a reaction force shown by arrow FH in the figure is generated on the other corner ridge 51f. Such generation of the reaction force FH prevents the recessed portion 64 from turning up, and causes the recessed portion 64 to buckle as shown in FIG. 26C. Therefore, the impact absorbing member 6 adopting the connecting segment 71 of inner connecting type has high shock energy absorbing performance. Thus, there are cases where pole collision tests can be passed even without providing the weakened portion 66.

The weakened portion 66 will be described now.

The weakened portions 66 shown in FIG. 25A are formed at outer ends, in the vehicle width direction, of a front portion and a rear portion of the top portion 62a of the hat portion 62 such that the stiffness of those portions is partially reduced. The weakened portion 66 is constituted by a circular hole penetrating the top portion 62a. The weakened portion 66 is not limited to a through hole, and although not illustrated, can be configured by irregularities formed by partially changing the thickness of the top portion 62a, notches, recesses, etc.

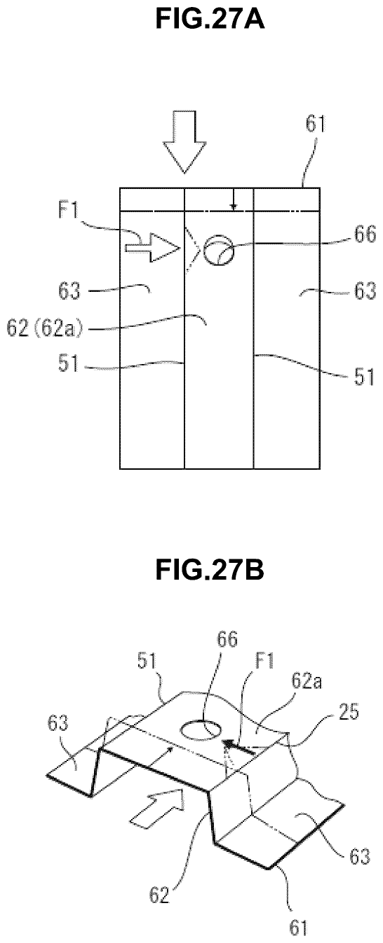

The impact absorbing member 6 shown in FIG. 25B mainly absorbs the impact energy of a pole collision applied from the side of the vehicle body. Here, a case will be described in which the vehicle body skids sideways such that the side of the vehicle body collides with a pillar-shaped body, that is, a case of a pole collision (hereinafter simply referred to as the “pole side collision”). When an impact force is applied to the impact absorbing member 6 from the side of the vehicle body (when an axial load is applied along the corner ridge 51), the top portion 62a, having the weakened portion 66, of the hat portion 62 is deformed, as shown in FIGS. 27A and 27B. FIGS. 27A and 27B show simplified views of the member constituting a half of a closed cross-sectional profile 61 shown in FIG. 25A. When an impact force is applied to the impact absorbing member 6 from the side of the vehicle body, the top portion 62a having the weakened portion 66 deforms, and a lateral force indicated by arrow F1 is generated on the corner ridge 51, resulting in lateral deformation, as shown in FIGS. 27A and 27B. In FIGS. 27A and 27B, the deformed shape is indicated by a two-dot chain line.

After the pole side collision, the top portion 62a having the weakened portion 66 is deformed (lateral deformation) first such that the portion, of the top portion 62a, having the weakened portion 66 is constricted when viewed from above. That is, the weakened portion 66 acts as a trigger to cause the top portion 62a to deform first. Following the deformation of the top portion 62a, the corner ridge 51 connected to the top portion 62a deforms (longitudinal deformation). If the above-mentioned lateral deformation does not occur, an excessive load acts on the corner ridge 51, causing the top portion 62a to deform significantly, resulting in part of the corner ridge 51 cracking to cause a longitudinal crack. As a result, the load that can be received by the impact absorbing member 6 is reduced and the amount of shock energy absorbed is decreased.

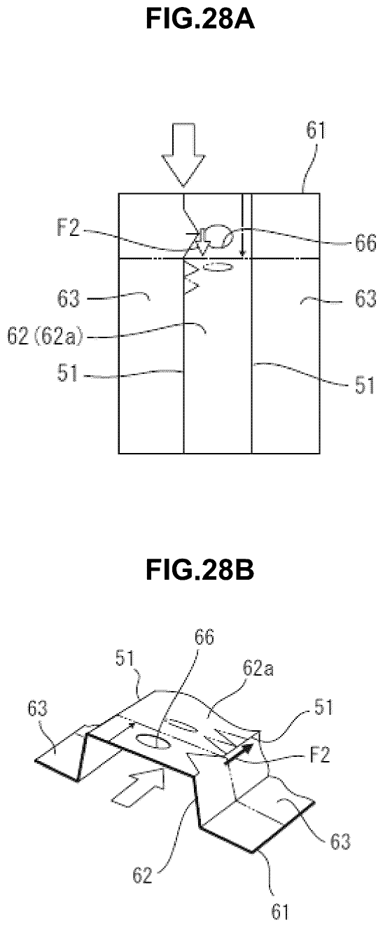

As described above, after the top portion 62a and the corner ridge 51 are laterally deformed around the weakened portion 66, the corner ridge 51 continues to undergo longitudinal deformation due to the longitudinal force F2 accompanied by the pole side collision, as shown in FIGS. 28A and 28B. Such longitudinal deformation occurs at a position adjacent, on the inner side in the vehicle width direction, to the portion where the above-mentioned lateral deformation had occurred. In the impact absorbing member 6 shown in FIG. 25B, four corner ridges 51 are formed on each of the periphery of the front hollow body 67 and the periphery of the rear hollow body 68. At each of the corner ridges 51, longitudinal deformation occurs successively. That is, when an impact force is applied to the impact absorbing member 6 from the side of the vehicle body, the top portion 62a at the outer end, in the vehicle width direction, of the impact absorbing member 6 deforms and the corner ridge 51 begins to deform from the outer end in the vehicle width direction, resulting in multiple stages of buckling deformation occurring successively over the entire length in the vehicle width direction, and thus the impact energy is absorbed.

Then, the corner ridges 51 of the front hollow body 67 and the rear hollow body 68 are axially crushed in a bellows-like manner, thereby the impact energy of the pole side collision is absorbed by the impact absorbing member 6.

Therefore, according to this embodiment, it is possible to provide an impact absorbing member that is capable of increasing the amount of shock energy absorbed while adopting a structure that promotes axial collapse.

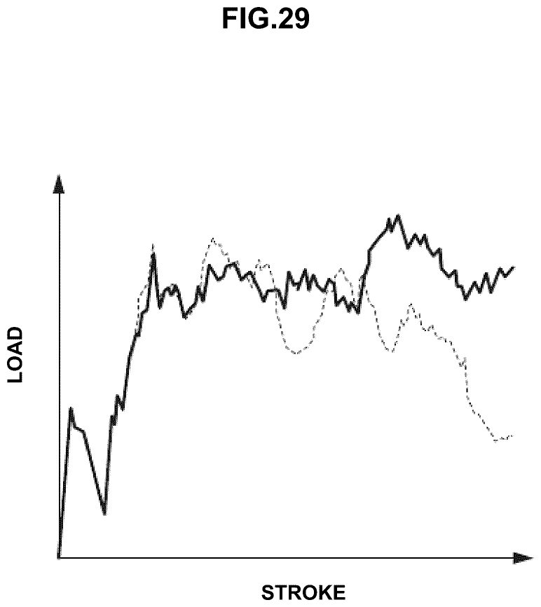

The magnitude of the impact absorbing energy was compared between the impact absorbing member 6 having the weakened portion 66 according to this embodiment and a comparative impact absorbing member not provided with the weakened portion 66, and the results shown in FIG. 29 were obtained. FIG. 29 shows a graph showing the relationship between the load applied due to a pole side collision and the deformation amount (stroke) of the impact absorbing member. In FIG. 29, the case where no weakened portion 66 (hole) is provided is indicated by a broken line, and the case where a weakened portion 66 (hole) is provided is indicated by a solid line. It can be considered that if the weakened portion 66 (hole) is not provided, an excessive load acts on the ridge line (corner ridge 51) causing a longitudinal crack, reducing the load and the impact energy that the impact absorbing member 6 can withstand.

To repeat, if the weakened portion 66 (hole) is not provided, no lateral force is generated and only longitudinal force is generated on the corner ridge 51, and therefore in the event of a pole side collision, a crack (longitudinal crack deformation) is formed in one axial direction (longitudinal direction). Meanwhile, when the weakened portion 66 according to this embodiment is provided, the impact force in a pole side collision is divided into a longitudinal force and a lateral force, which generates lateral and longitudinal deformations, thereby absorbing the impact. When the corner ridge 51 deforms laterally, the load required to cause longitudinal deformation decreases, but not as much as when a longitudinal crack is formed, and longitudinal deformation also occurs, and therefore the impact absorption energy (load x stroke) of the pole side impact can be increased.

The weakened portion 66 (hole) shown in this embodiment is constituted by a through hole. The shape of the opening on the weakened portion 66 is a perfect circle. Moreover, the weakened portion 66 shown in FIG. 25A is drilled on a center line, extending in the vehicle width direction, at a position equidistant from the front corner ridge 51 and the rear corner ridge 51 at the front and rear portions sandwiching the recessed portion 64 of the top portion 62a. The reason for forming the weakened portions 66 in this manner is to allow the front and rear corner ridges 51 to buckle simultaneously. The pitch, in the vehicle width direction, of the buckling of the corner ridge 51 due to lateral and longitudinal deformation varies depending on the diameter of the weakened portion 66, and can be easily adjusted by changing the diameter. The diameter is sized to not obstruct the front and rear corner ridges 51 and allows the insertion of a spot welding gun (not illustrated) used in an automobile factory. If the weakened portion 66 is formed by a cutout that interferes the edge of the top portion 62a on the outer side in the vehicle width direction, buckling begins at an early stage of a collision. By increasing the strength of the material of the steel plate forming the member constituting a half of a closed cross-sectional profile 61 and thus making lateral deformation less likely to occur, the diameter of the weakened portion 66 can be increased or the shape thereof can be changed from a perfect circle to an ellipse or rectangle that is elongated in the vehicle width direction.

The weakened portion 66 is formed for the purpose of triggering buckling in the early stage of a collision. For this reason, one weakened portion at the end of the impact absorbing member on the impact side is sufficient, but when the strength of the material is increased, such as the case of high-strength steel plate, and thus making buckling less likely to occur, the likelihood of buckling can be adjusted by softening the top portion 62a by carrying out heat treatment or by drilling holes on the center line on the top portion 62a in a region from the outer end in the vehicle width direction to the inner central portion in the vehicle width direction.

### Fourth Embodiment

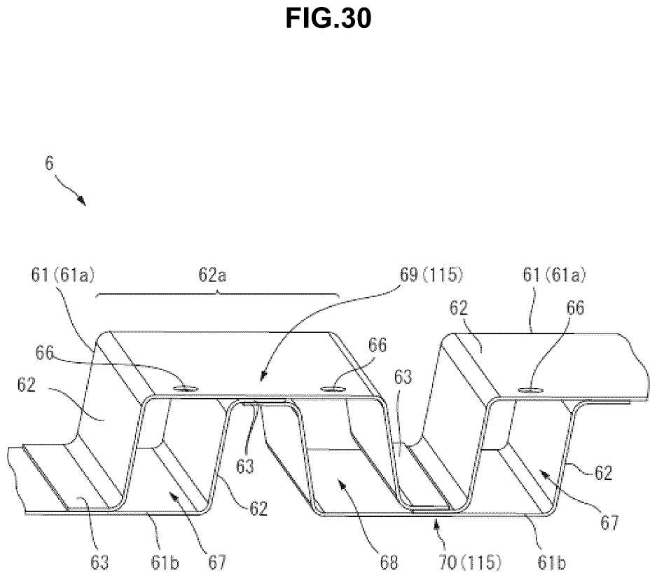

The impact absorbing member having a connecting segment of inner connecting type can be constructed as shown in FIG. 30. In FIG. 30, components that are the same as or commensurate with those described with reference to FIGS. 25A and 25B are given the same reference numerals, and detailed descriptions thereof will be omitted as appropriate.

The hat portions 62 of the upper member constituting a half of a closed cross-sectional profile 61a and the lower member constituting a half of a closed cross-sectional profile 61b constituting the impact absorbing member 6 shown in FIG. 30 do not have the recessed portion 64 shown in FIG. 25B.

The upper connecting segment 69 that connects the upper ends of the front hollow body 67 and the rear hollow body 68 of the impact absorbing member 6 shown in FIG. 30 together, and the lower connecting segment 70 that connects the lower ends of the front hollow body 67 and the rear hollow body 68 together are “connecting segments 115 of inner connecting type” in which the flange portion 63 is joined to the inner side of the hat portion 62. Therefore, compared to the case where the connecting segment 15 is an “connecting segment of outer connecting type” as in the impact absorbing member 6 shown in FIG. 3A, the impact absorbing member 6 shown in FIG. 30 has high impact energy absorption performance.

The weakened portion 66 of the impact absorbing member 6 shown in FIG. 25B or FIG. 30 is formed in the upper member constituting a half of a closed cross-sectional profile 61a. However, the weakened portion 66 may be provided in the lower member constituting a half of a closed cross-sectional profile 61b, or may be provided in both the upper member constituting a half of a closed cross-sectional profile 61a and the lower member constituting a half of a closed cross-sectional profile 61b. In this way, by providing the weakened portion 66 in the upper member constituting a half of a closed cross-sectional profile 61a and the lower member constituting a half of a closed cross-sectional profile 61b corresponding to the upper member constituting a half of a closed cross-sectional profile 61a, it is possible to press-form the upper member constituting a half of a closed cross-sectional profile 61a and the lower member constituting a half of a closed cross-sectional profile 61b using the same mold, thereby improving productivity.

### Fifth Embodiment

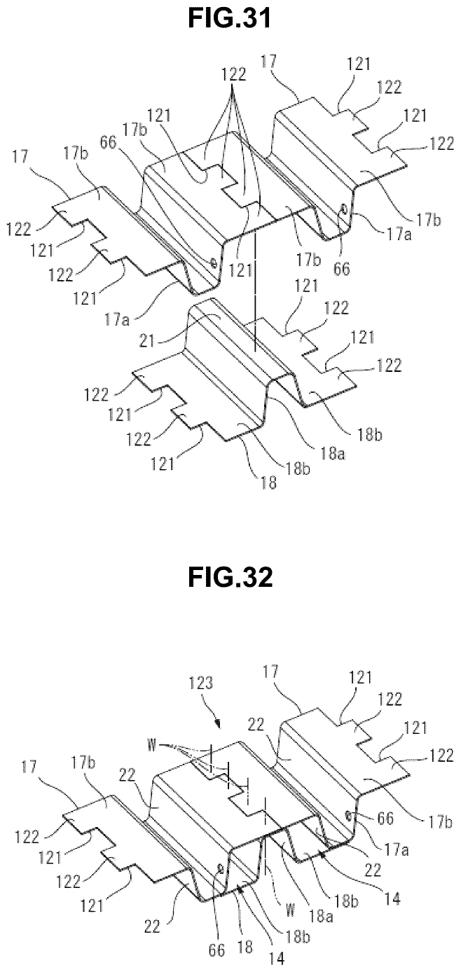

The connecting portion between the members each constituting a half of a closed cross-sectional profile lined up along the vehicle front-rear direction (longitudinal direction of the impact absorbing member 6) can be configured as shown in FIGS. 31 and 32. In FIGS. 31 and 32, components that are the same as or commensurate with those described with reference to FIGS. 1-30 are given the same reference signs and detailed descriptions thereof will be omitted as appropriate.

The flange portions 17b, 18b of the first member constituting a half of a closed cross-sectional profile 17 and the second member constituting a half of a closed cross-sectional profile 18 shown in FIG. 30 are configured such that adjacent ones in the front-rear direction can be combined with each other.

More specifically, the front ends, of the flange portions 17b, 18b, located frontward of the hat portions 17a, 18a are each provided with two notches 121 extending in the front-rear direction and two protrusions 122 adjacent to the notches 121 in the vehicle width direction. The rear ends, of the flange portions 17b, 18b, located rearward of the hat portions 17a, 18a are each provided with two notches 121 extending in the front-rear direction and two protrusions 122 adjacent to the notches 121 in the vehicle width direction. The notches 121 and the protrusions 122 are arranged alternately in the vehicle width direction. The size of the notch 121 (width in the front-rear direction and width in the vehicle width direction) is such that a protrusion 122 formed on another first or second member constituting a half of a closed cross-sectional profile 17, 18 can be inserted therein.

In order to combine the two first members each constituting a half of a closed cross-sectional profile 17, 17 shown in FIG. 31 in the front-rear direction, a protrusion 122 formed on the front flange portion 17b of a rear first member constituting a half of a closed cross-sectional profile 17 is inserted into a notch 121 formed on the rear flange portion 17b of a front first member constituting a half of a closed cross-sectional profile 17. As shown in FIG. 32, the protrusion 122 on this portion to be combined is overlapped with the hat portion 18a of the second member constituting a half of a closed cross-sectional profile 18, and is welded to the top portion 21 of the hat portion 18a by spot welding. In FIG. 32, axes of the two electrodes when performing spot welding are indicated by two-dot chain lines W.

That is, two protrusions 122 formed on the rear flange portion 17b of the front first member constituting a half of a closed cross-sectional profile 17 and two protrusions 122 formed on the front flange portion 17b of the rear first member constituting a half of a closed cross-sectional profile 17 are welded to the hat portion 18a of one second member constituting a half of a closed cross-sectional profile 18. By welding the two first members each constituting a half of a closed cross-sectional profile 17, 17 and one second member constituting a half of a closed cross-sectional profile 18 together in this manner, one structure configuring a closed cross-sectional profile 123 is formed as shown in FIG. 32.

In the structure configuring a closed cross-sectional profile 123 shown in FIG. 32, two hollow bodies 14 are formed on both sides of the hat portion 18a of the second member constituting a half of a closed cross-sectional profile 18. Moreover, in this structure configuring a closed cross-sectional profile 123, a weakened portion 66 is formed in a rear inclined wall 22 of the pair of inclined walls 22 that constitute the hat portion 17a of the first member constituting a half of a closed cross-sectional profile 17. Although not illustrated, a weakened portion 66 can also be formed on upper and lower walls of the hollow body 14, i.e., on the flange portions 17b and 18b.

In the structure configuring a closed cross-sectional profile 123 shown in FIG. 32, the joining portion between the two first members each constituting a half of a closed cross-sectional profile 17 and one second member constituting a half of a closed cross-sectional profile 18 is in a two-ply state stacked in the up-down direction (thickness direction of the flange portions 17b, 18b).

If the first member constituting a half of a closed cross-sectional profile 17 and the second member constituting a half of a closed cross-sectional profile 18 are formed into a shape having one or two hat portions 17a, 18a in order to improve productivity, the number of structures each configuring a closed cross-sectional profile 20 required to form the impact absorbing member 6 increases. In this case, the thickness of the connecting portion between the structures each configuring a closed cross-sectional profile 20 may become thick, and there is a risk that the strength of this connecting portion becomes greater than that of the hollow body 14. However, by forming the notches 121 and the protrusions 122 in the flange portions 17b, 18b, the connecting portion between the structures each configuring a closed cross-sectional profile 20 can be made into a two-ply state as described above, and therefore the difference in strength distribution between the connecting portion and the hollow body 14 can be eliminated. This makes it possible to prevent the axial collapse of the hollow body from being hindered by the connecting portion. Moreover, in some cases, it may be possible to overlap another plate-shaped accessory (not illustrated) on the connecting portion and perform sandwiching spot welding of three plates.

### REFERENCE SIGNS LIST

6: impact absorbing member; 7: inner side sill; 8: outer side sill; 14: hollow body; 15: connecting segment; 16: closed cross-sectional profile; 17: first member constituting a half of a closed cross-sectional profile; 18: second member constituting a half of a closed cross-sectional profile; 17a, 18a, 62: hat portion; 17b, 18b, 63: flange portion; 19: hollow structure; 21, 62a: top portion; 23: (outer sill) fixing member; 51: corner or corner ridge; 52: recess; 61: member constituting a half of a closed cross-sectional profile; 64: recessed portion; 66: weakened portion; 67: front hollow body; 68: rear hollow body; 69: upper connecting segment; 70: lower connecting segment; 121: notch; 122: protrusion; S1, S11, S21, S31: a step of forming a plurality of members each constituting a half of a closed cross-sectional profile; S2: a step of forming a structure configuring a closed cross-sectional profile; S3: a step of forming an impact absorbing member having a long length; S12, S22: a step of forming an intermediate part; S13, S23: a step of forming an impact absorbing member having a long length by joining intermediate parts together; S32: a step of forming an impact absorbing member by coupling the members each constituting a half of a closed cross-sectional profile with each other; S42: a step of joining the outer side sill to the impact absorbing member; S43: a step of joining the outer side sill 8 and the inner side sill together; S51: a step of joining the impact absorbing member to the inner side sill; S52: a step of joining the outer side sill to the inner side sill

1.-19. (canceled)

20. A method for manufacturing an impact absorbing member, comprising:
forming a member constituting a half of a closed cross-sectional profile by press-forming a steel plate blank into a part having a hat-shaped cross-section including a top portion of a hat portion, a pair of inclined walls, a pair of recesses each including the inclined wall, and a pair of flange portions; and
forming a plurality of closed cross-sectional profile configurations coupled by connecting segments in only a longitudinal direction, which is a direction in which the flange portion protrudes from the hat portion, by combining at least three closed cross-sectional profile constituting halves in such a manner that there are the closed cross-sectional profile having convex directions of the hat portions opposite to each other, and overlapping and joining the top portion constituting half of the hat portion of one closed cross-sectional profile constituting half with the flange portion of another closed cross-sectional profile constituting half such that the closed cross-sectional profile configuration extends in the longitudinal direction, the closed cross-sectional profile configuration including upper and lower recesses each formed in part by the inclined wall of the hat portion, and the connecting segment being formed by overlapping the flange portion and the top portion in a thickness direction, wherein
the closed cross-sectional profile configuration includes the connecting segment between the closed cross-sectional profile configuration and an adjacent hollow body which has a prismatic shape and which extends in a direction perpendicular to the longitudinal direction,
a plurality of connecting segments are arranged in the longitudinal direction,
the hollow body forms a closed cross-sectional profile with the upper and lower recesses, and
each of an upper side and a lower side of the closed cross-sectional profile includes at least two corner ridges extending in a direction perpendicular to the longitudinal direction.

21. The method for manufacturing an impact absorbing member according to claim 20, wherein
at least one of, a stepped-shape, a minuscule recess, two or more small second recesses, a raised portion, and a shape recessed to form a V-shape in cross-section, is added to the recess.

22. The method for manufacturing an impact absorbing member according to claim 20, wherein
the impact absorbing member includes a fixing member which protrudes outward from the inclined wall of an opposing hat portion of the closed cross-sectional profile constituting half of the impact absorbing member.

23. A method for manufacturing a side sill, comprising:
joining an impact absorbing member formed by the method according to claim 1 to an outer side sill; and
joining the outer side sill, to which the impact absorbing member is joined, and an inner side sill.

24. A method for manufacturing a side sill, comprising:
joining an impact absorbing member formed by the method according to claim 1 to an inner side sill; and
joining the inner side sill, to which the impact absorbing member is joined, and an outer side sill.

25. An impact absorbing member formed of a plurality of closed cross-sectional profile configurations coupled by connecting segments in only a longitudinal direction, wherein
the plurality of closed cross-sectional profile configurations are formed by combining at least three closed cross-sectional profile constituting halves in such a manner that there are closed cross-sectional profile constituting halves having convex directions of the hat portions opposite to each other, and overlapping and joining the top portion of the hat portion of one closed cross-sectional profile constituting half with the flange portion of another closed cross-sectional profile constituting half such that the closed cross-sectional profile configuration extends in the longitudinal direction, the closed cross-sectional profile constituting half having a hat-shaped cross-section including a top portion of a hat portion, a pair of inclined walls, a pair of recesses each including the inclined wall, and a pair of flange portions, the longitudinal direction being a direction in which the flange portion protrudes from the hat portion, the closed cross-sectional profile configuration including upper and lower recesses each formed in part by the inclined wall of the hat portion, and the connecting segment being formed by overlapping the flange portion and the top portion in a thickness direction,
the closed cross-sectional profile configuration includes the connecting segment between the closed cross-sectional profile configuration and an adjacent hollow body which has a prismatic shape and which extends in a direction perpendicular to the longitudinal direction,
a plurality of connecting segments are arranged in the longitudinal direction,
the hollow body forms a closed cross-sectional profile with the upper and lower recesses, and
each of an upper side and a lower side of the closed cross-sectional profile includes at least two corner ridges extending in a direction perpendicular to the longitudinal direction.
